(19) United States
(12) Patent Application Publication
(10) Pub. No.: US 2007/0030269 A1
(43) Pub. Date: Feb. 8, 2007

(54) Universal Performance Alignment

(76) Inventor: David W. Henry, Marietta, GA (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 11/462,195

(22) Filed: Aug. 3, 2006

Related U.S. Application Data
(60) Provisional application No. 60/705,097, filed on Aug. 3, 2005.

(51) Int. Cl. G06T 11/20

(52) U.S. Cl. 345/440

(57) ABSTRACT

At least one embodiment of a system and method for performance alignment includes a determining component configured to determine at least one success factor related to a project and a first receiving component configured to receive data related to the success factor. A providing component may be configured to provide a graphical representation of the received data, wherein the graphical representation is configured to align at least a portion of the received data with at least one reference point.

### CROSS REFERENCE

This application claims the benefit of U.S. Provisional Application No. 60/705,097, filed Aug. 3, 2005, which is incorporated by reference in its entirety.

### TECHNICAL FIELD

This disclosure relates to performance alignment and, more specifically, to performance factors toward a desired outcome.

### BACKGROUND

As individuals and/or organizations undertake a project, they often fail to understand a desired outcome of a project and/or one or more performance factors (e.g., activities, events, etc.) to achieve the desired outcome. Additionally, individuals and/or organizations may also fail to understand how those performance factors affect the achievement of the desired outcome. Additionally, the individuals and/or organizations may fail to understand the resulting cost due to misalignment of one or more of the performance factors. As such, many projects fail with little or no indication of the reasons of failure.

Thus, a heretofore unaddressed need exists to address the aforementioned deficiencies and inadequacies.

### BRIEF DESCRIPTION

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, there is no intent to limit the disclosure to the embodiment or embodiments disclosed herein. On the contrary, the intent is to cover all alternatives, modifications, and equivalents.

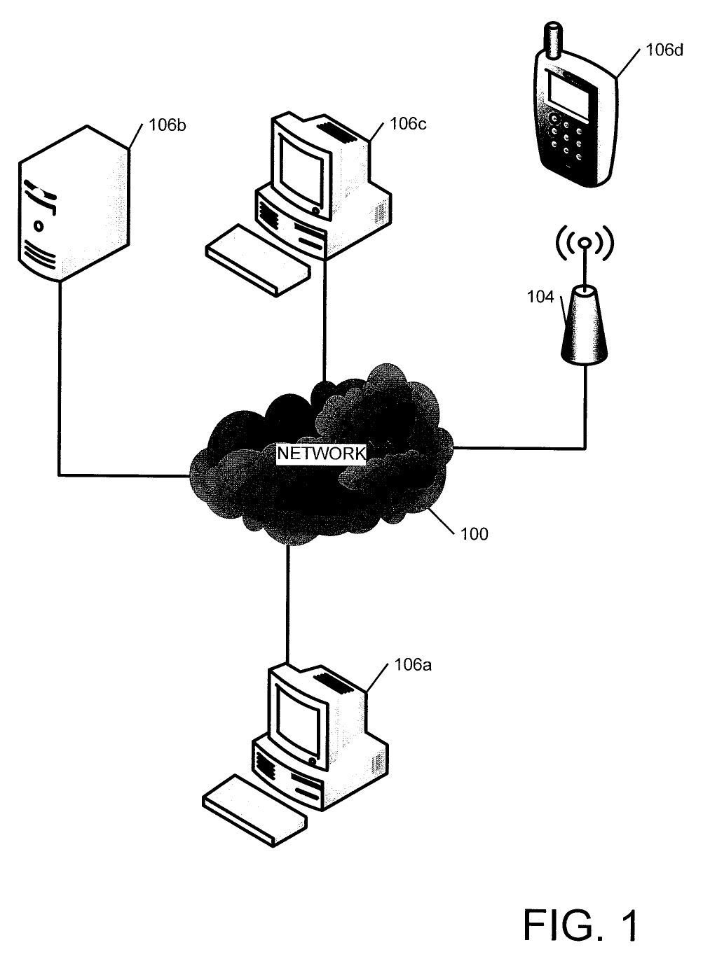

FIG. 1 is a functional diagram of an exemplary communications network environment, by which a user can utilize performance logic.

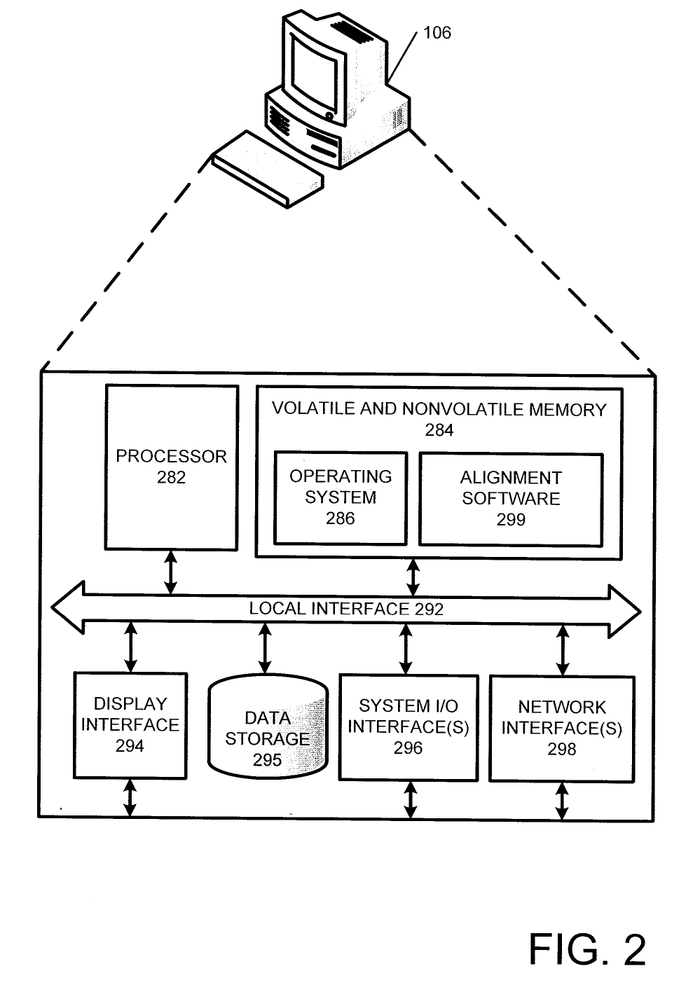

FIG. 2 is a functional diagram illustrating an exemplary embodiment of a computing device that may be configured to communicate via a communications network such as the network from FIG. 1.

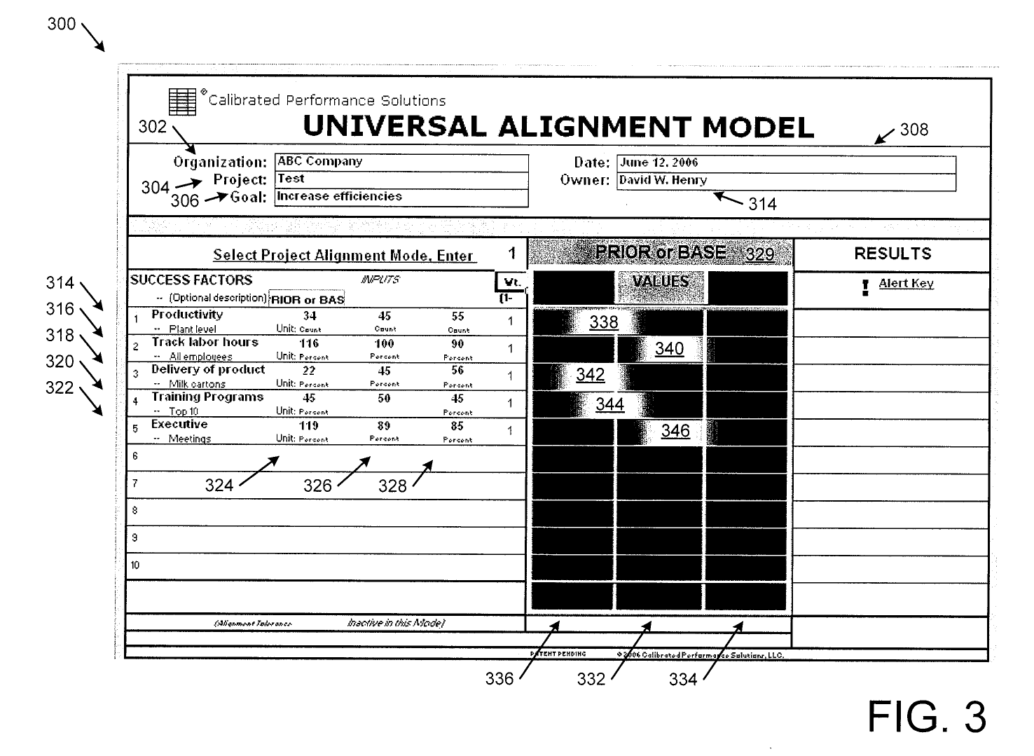

FIG. 3 is an exemplary user interface illustrating alignment of base performance data, which may be provided by the computing device from FIG. 2.

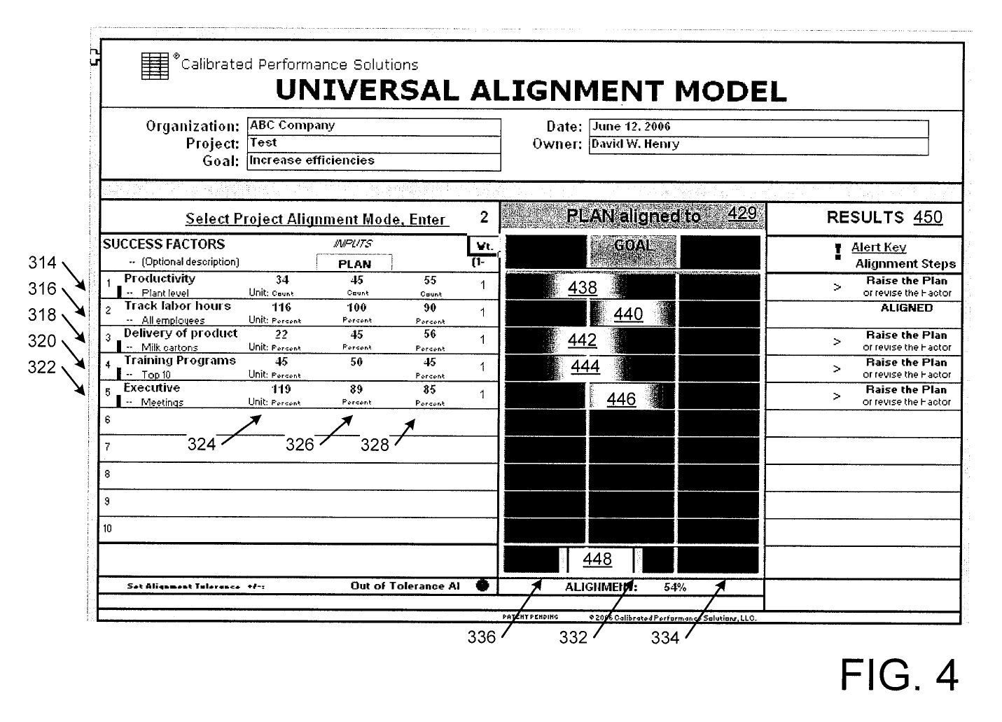

FIG. 4 is an exemplary user interface illustrating alignment of plan performance data, similar to the interface from FIG. 3.

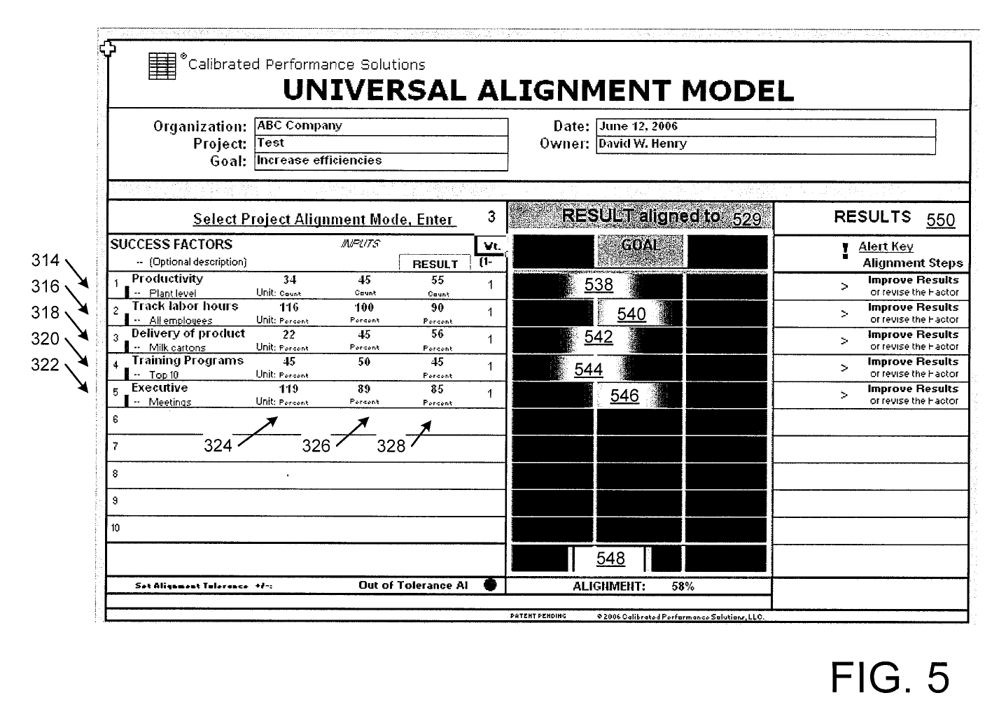

FIG. 5 is an exemplary user interface illustrating alignment of actual performance data, similar to the interface from FIG. 4.

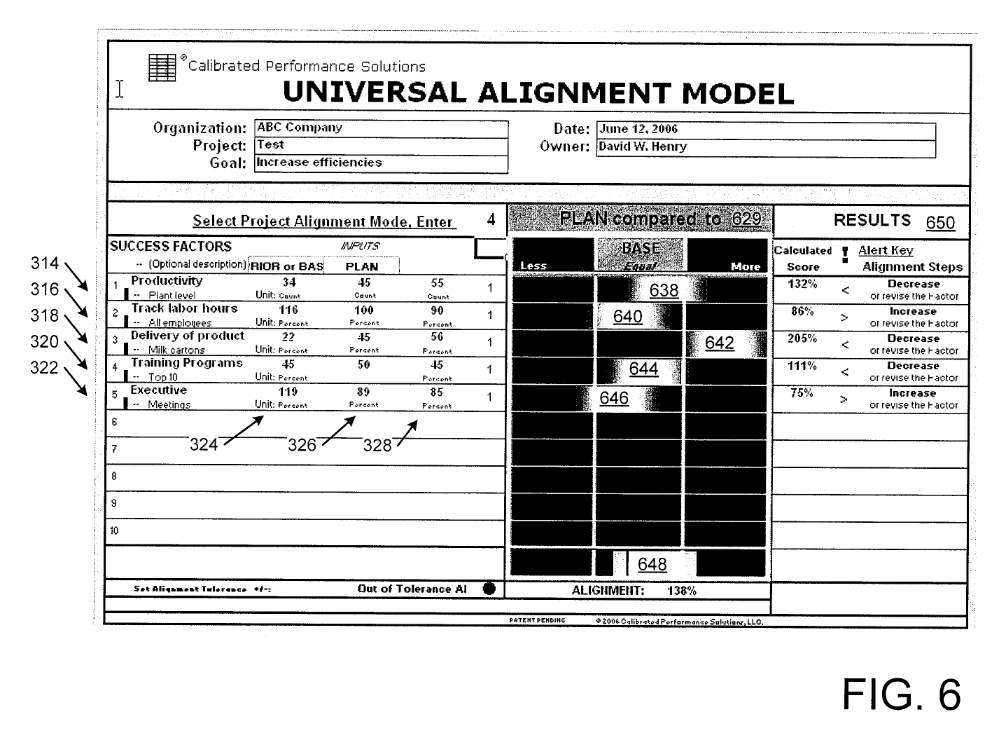

FIG. 6 is an exemplary user interface illustrating an alignment comparison of base performance data and plan performance data, similar to the interface from FIG. 5.

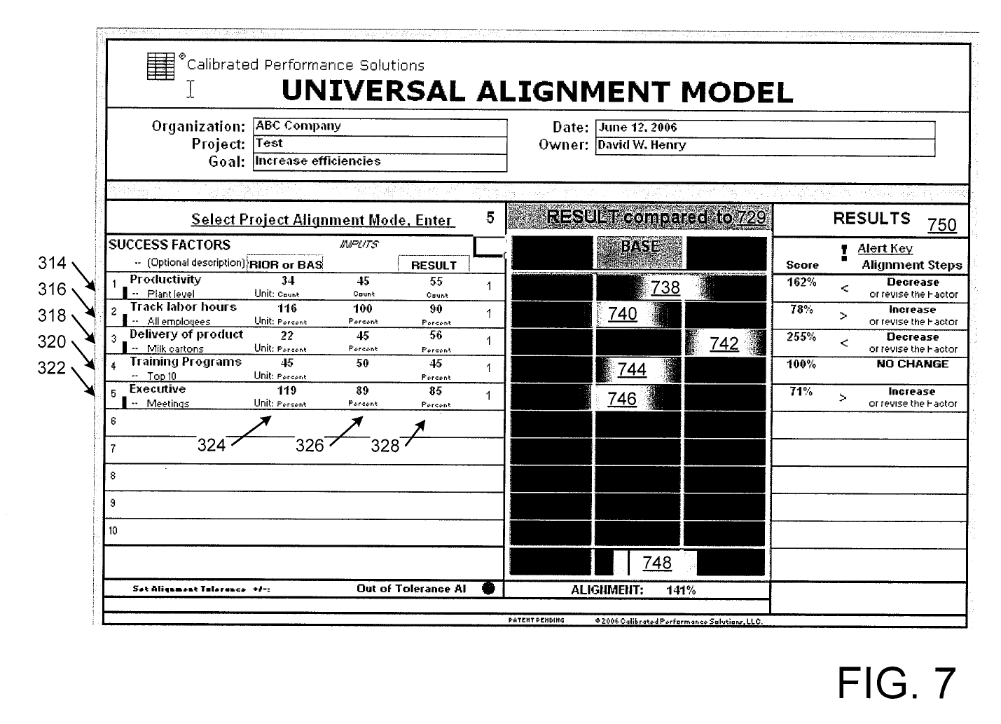

FIG. 7 is an exemplary user interface illustrating an alignment comparison of base performance data and actual performance data, similar to the interface from FIG. 6.

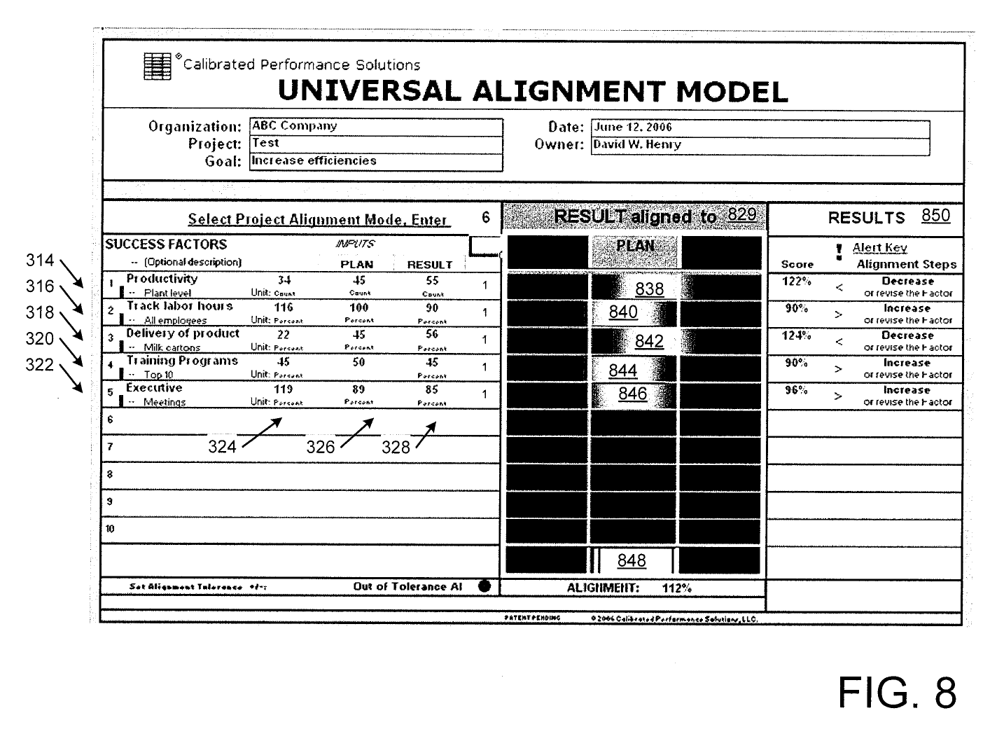

FIG. 8 is an exemplary user interface illustrating an alignment comparison of plan performance data and actual performance data, similar to the interface from FIG. 7.

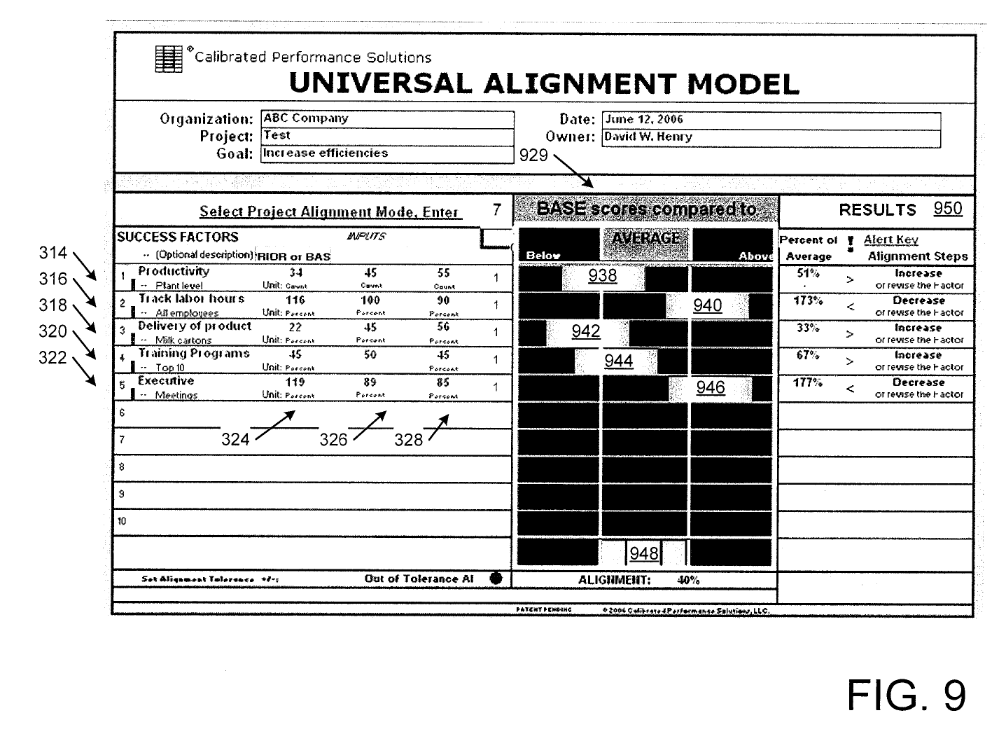

FIG. 9 is an exemplary user interface illustrating an alignment comparison of base performance data and average base performance data, similar to the interface from FIG. 8.

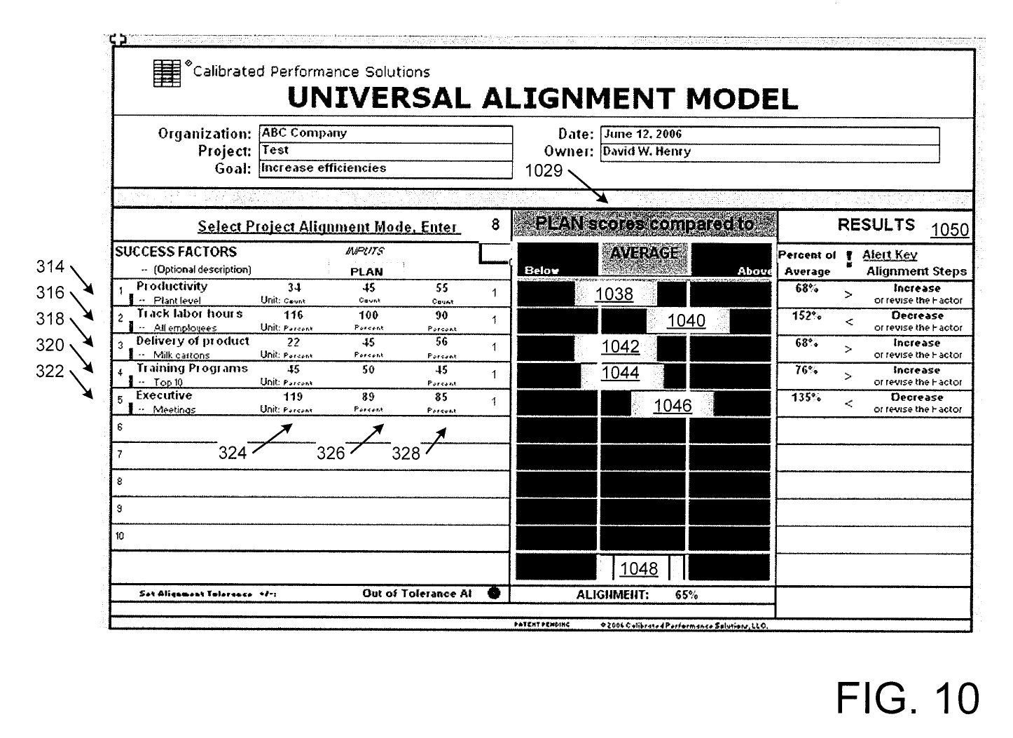

FIG. 10 is an exemplary user interface illustrating an alignment comparison of plan performance data and average plan performance data, similar to the interface from FIG. 9.

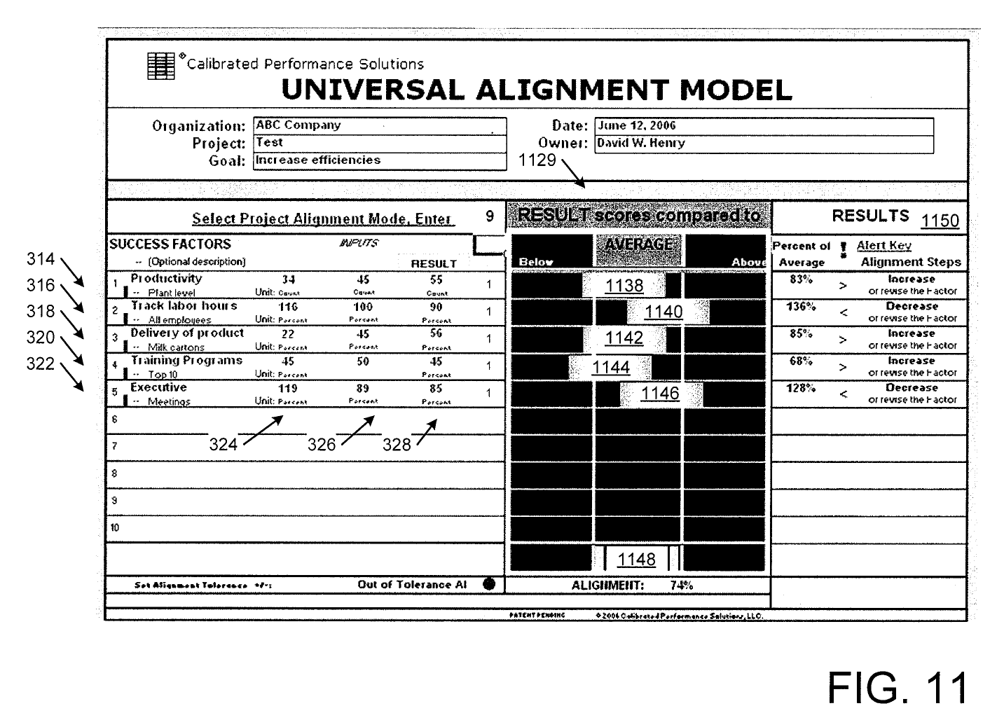

FIG. 11 is an exemplary user interface illustrating an alignment comparison of actual performance data and average actual performance data, similar to the interface from FIG. 10.

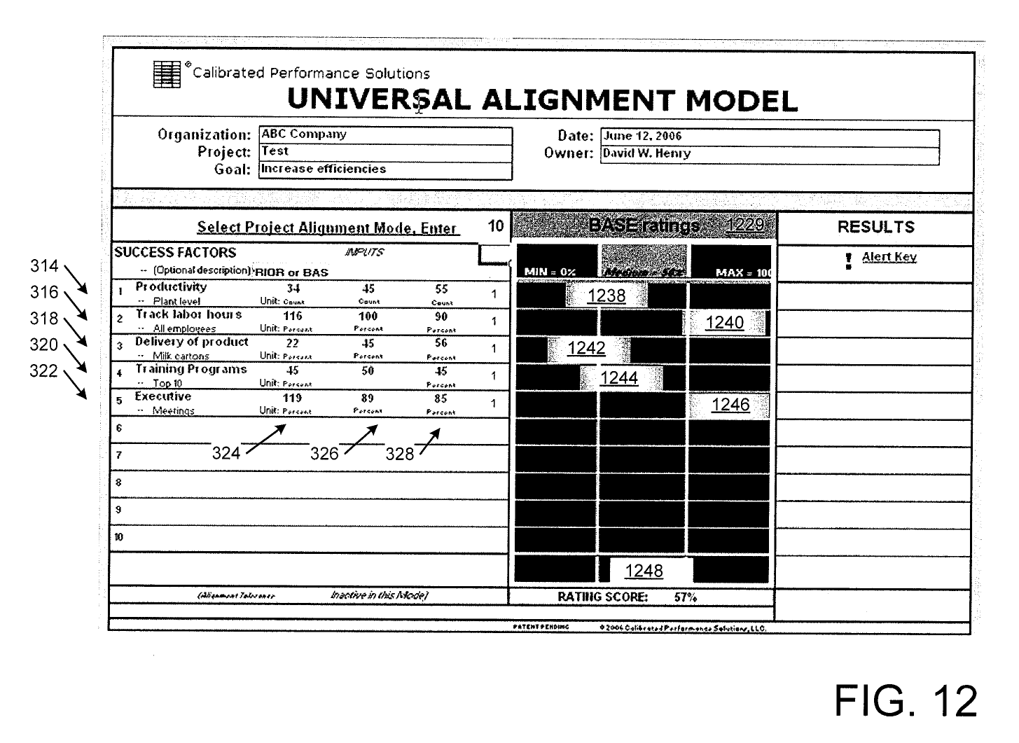

FIG. 12 is an exemplary user interface illustrating an alignment representation of base performance data, similar to the interface from FIG. 10.

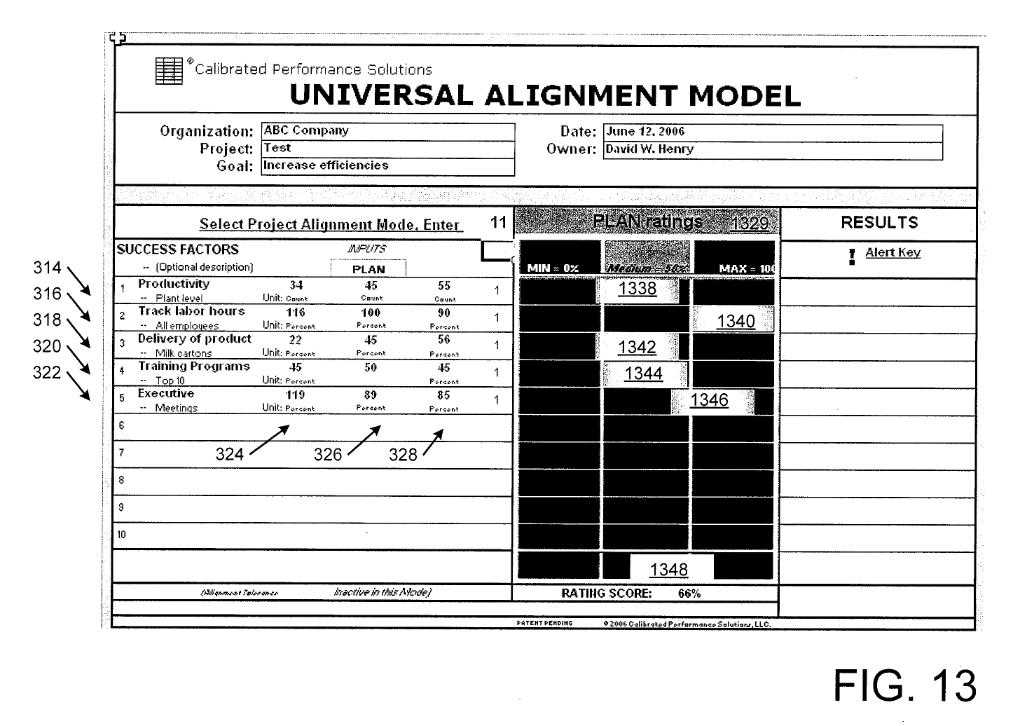

FIG. 13 is an exemplary user interface illustrating an alignment representation of plan performance data, similar to the interface from FIG. 12.

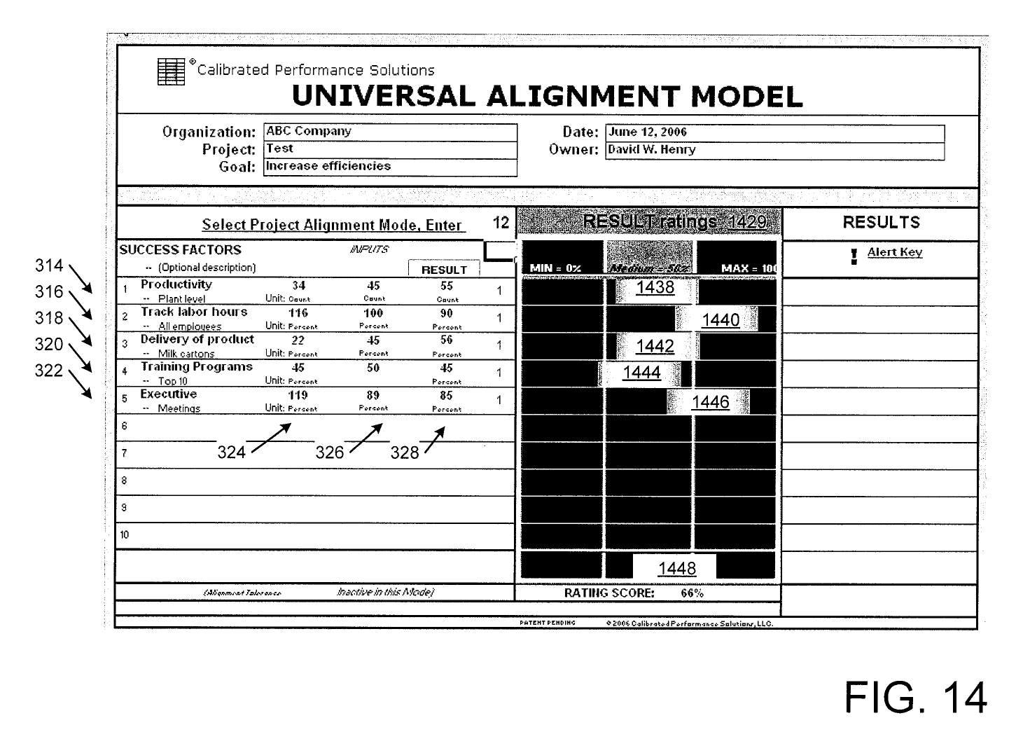

FIG. 14 is an exemplary user interface illustrating an alignment representation of actual performance data, similar to the interface from FIG. 13.

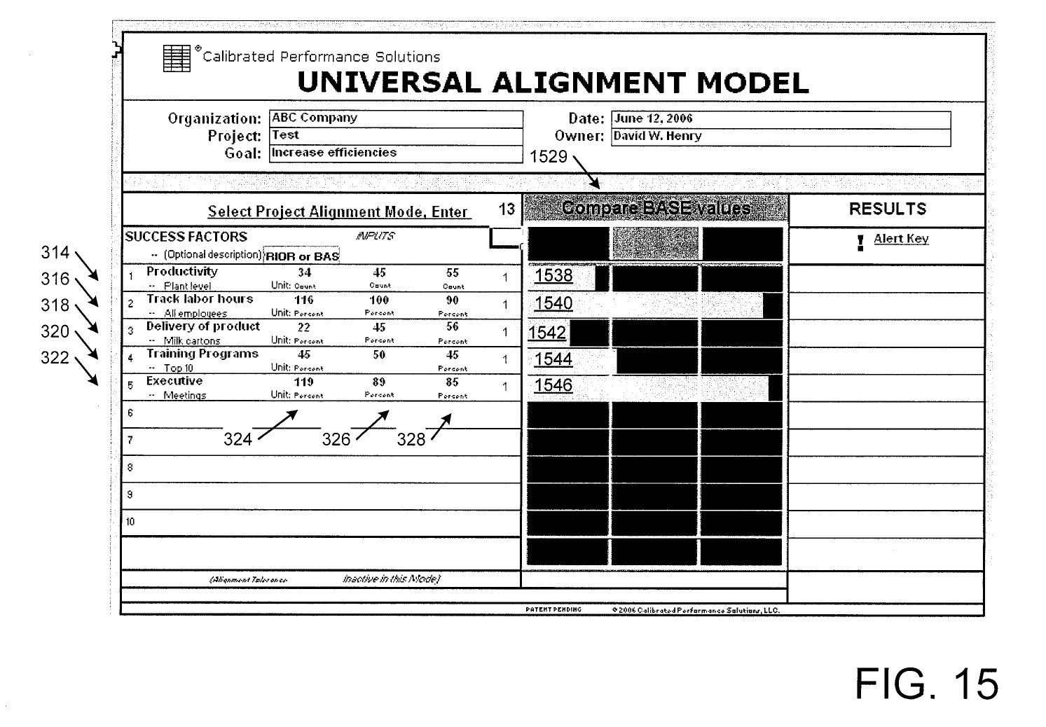

FIG. 15 is an exemplary user interface illustrating a bar graph representation of base performance data, similar to the interface from FIG. 14.

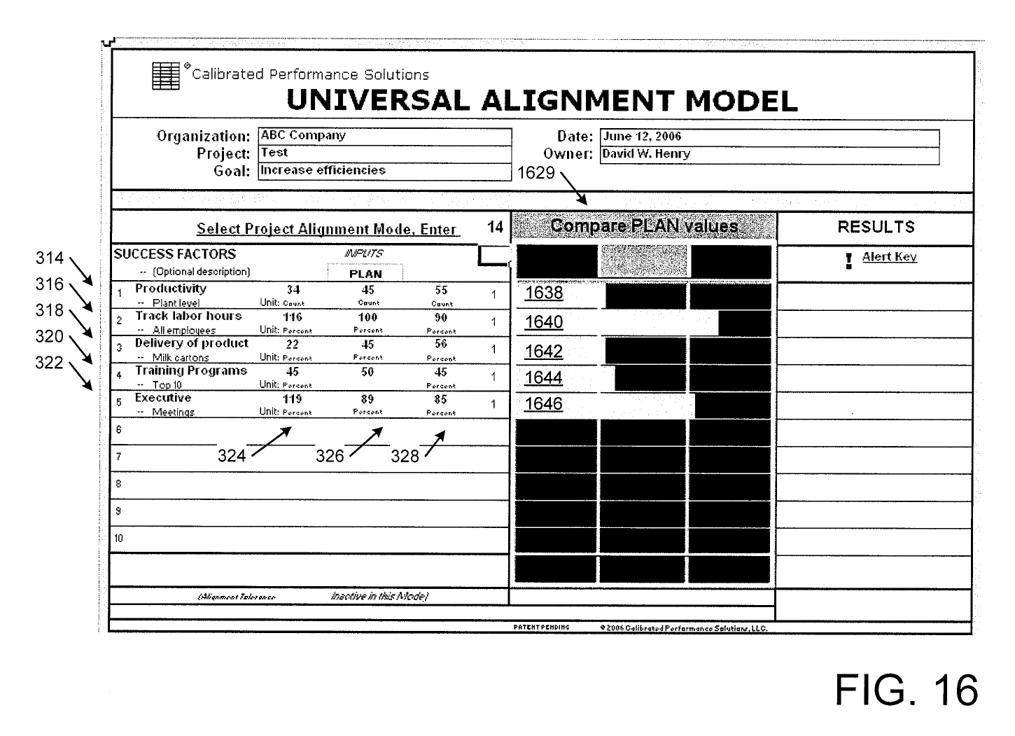

FIG. 16 is an exemplary user interface illustrating a bar graph representation of plan performance data, similar to the interface from FIG. 15.

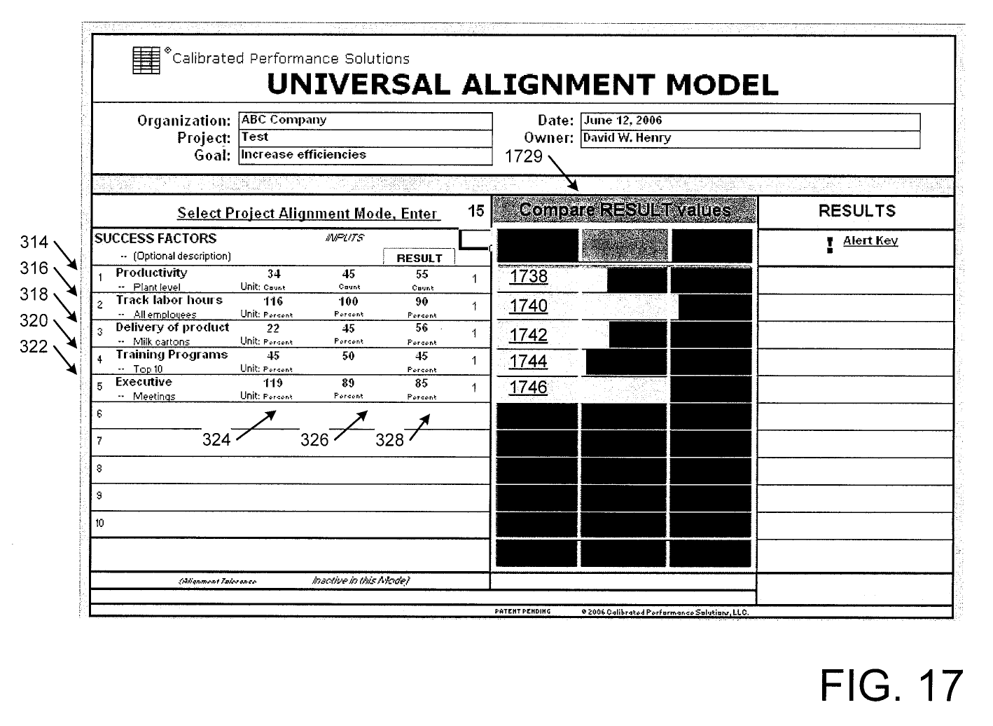

FIG. 17 is an exemplary user interface illustrating a bar graph representation of actual performance data, similar to the interface from FIG. 16.

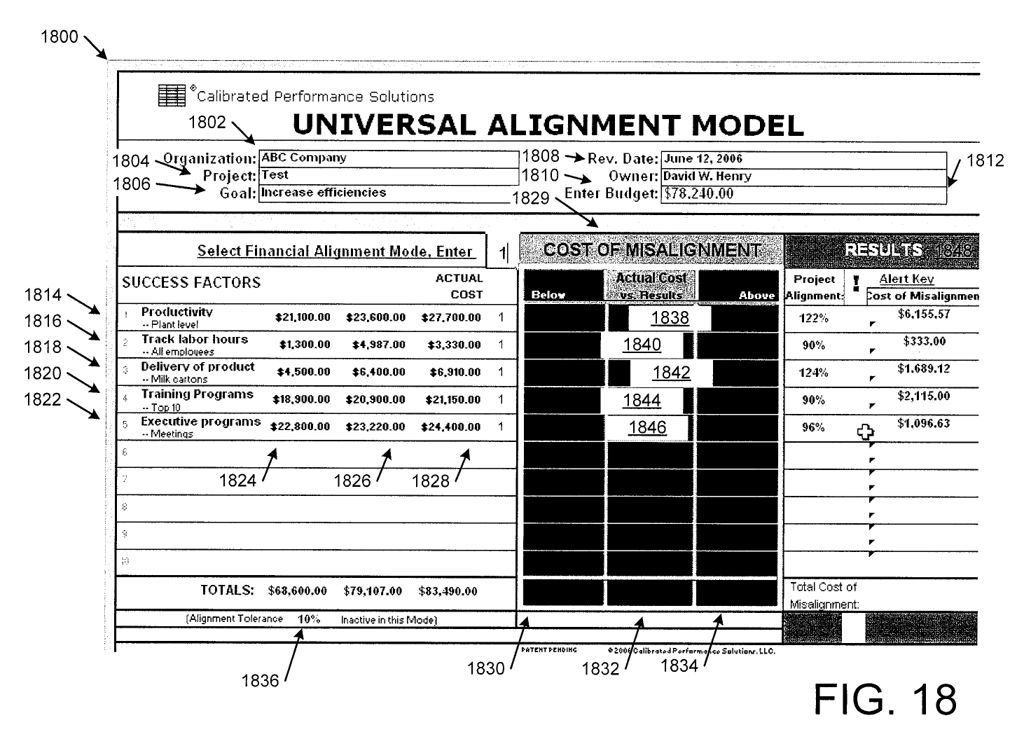

FIG. 18 is an exemplary user interface illustrating alignment of a plurality of factors, which may be displayed on the computing device from FIG. 2.

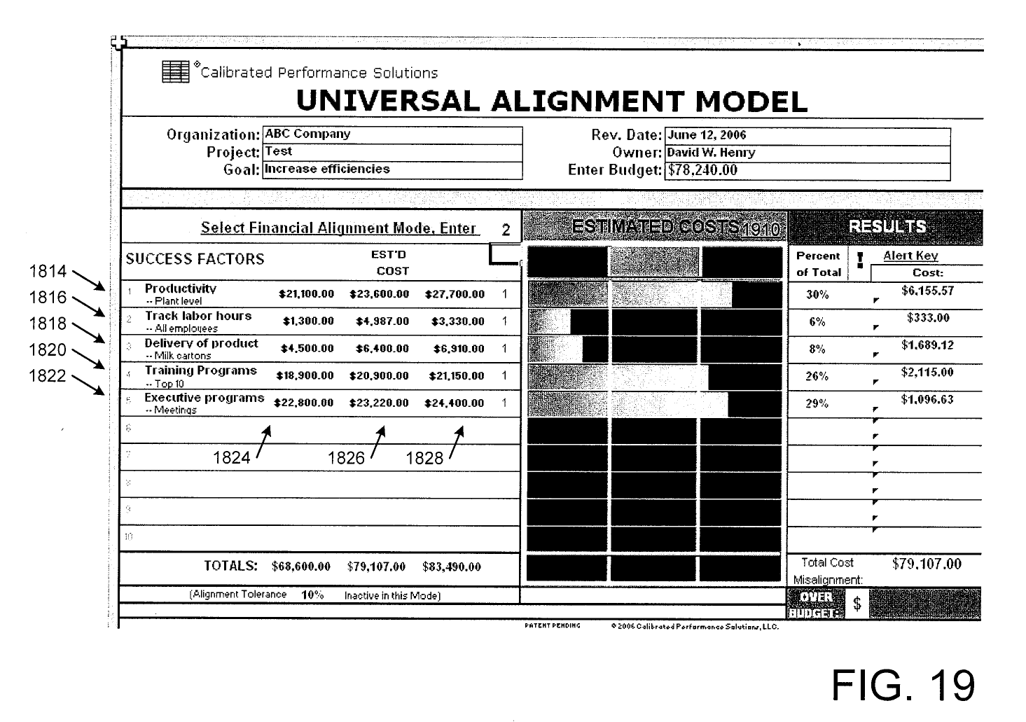

FIG. 19 is an exemplary user interface illustrating estimated performance related to a plurality of factors, similar to the user interface from FIG. 18.

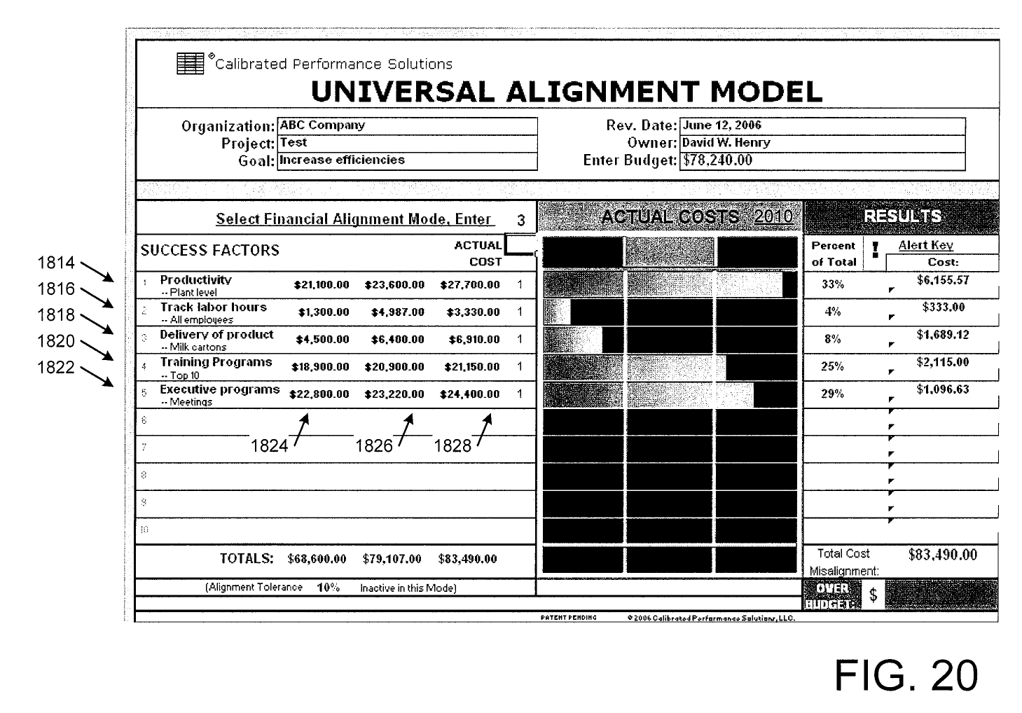

FIG. 20 is an exemplary user interface illustrating actual performance related to a plurality of factors, similar to the user interface from FIG. 19.

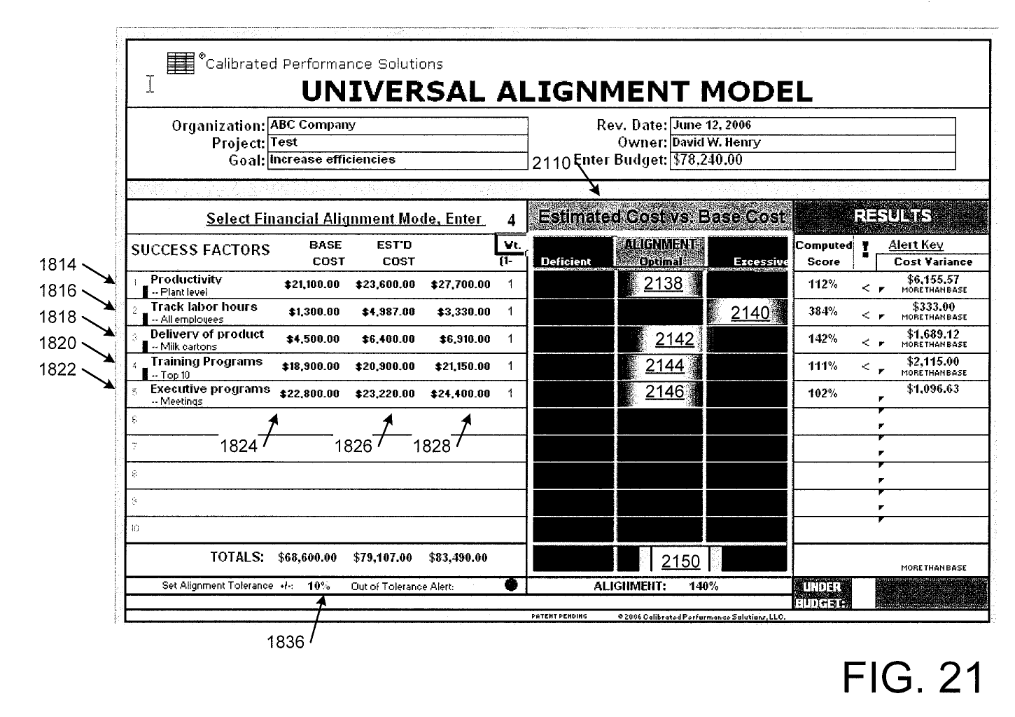

FIG. 21 is an exemplary user interface illustrating a comparison of estimated performance and base performance, similar to the user interface from FIG. 20.

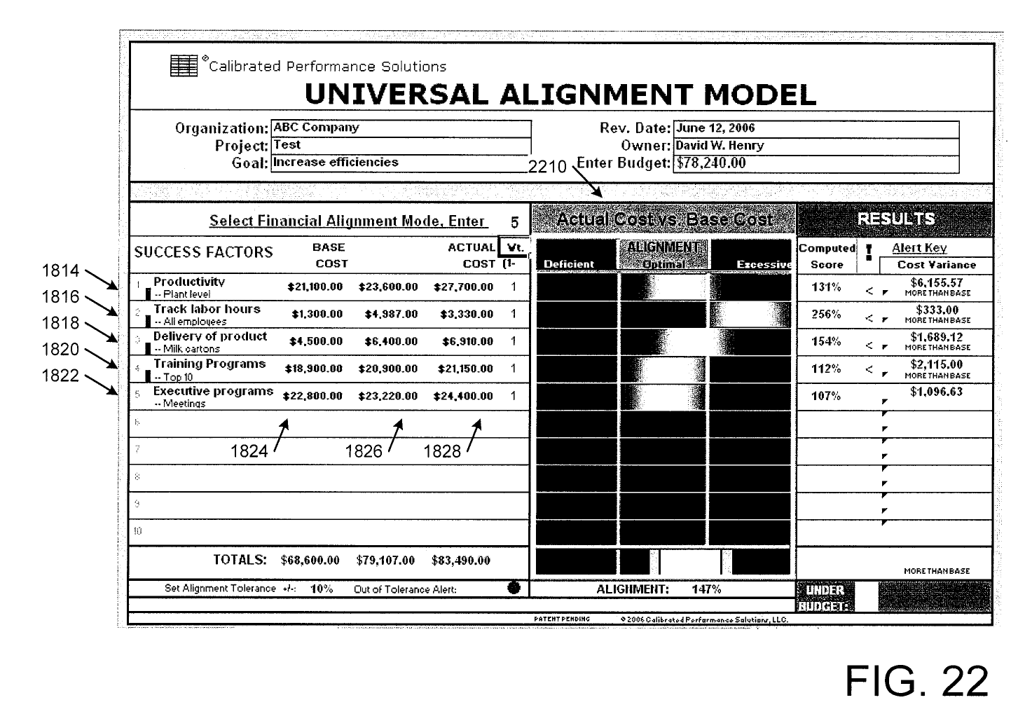

FIG. 22 is an exemplary user interface illustrating a comparison of actual performance and base performance, similar to the user interface from FIG. 21.

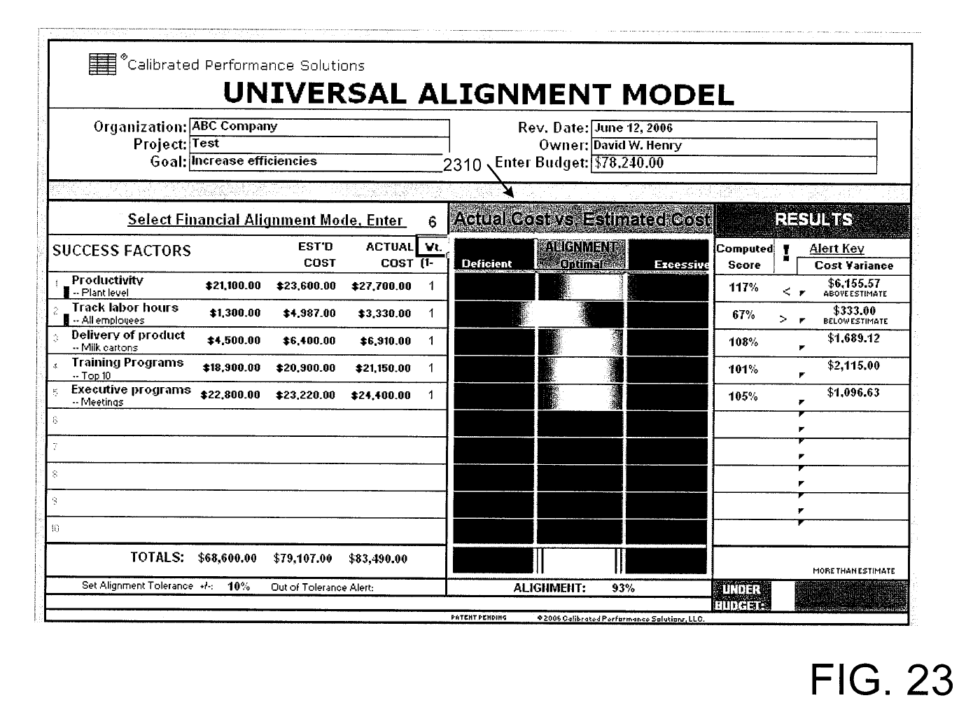

FIG. 23 is an exemplary user interface illustrating a comparison of actual performance and estimated performance, similar to the user interface from FIG. 22.

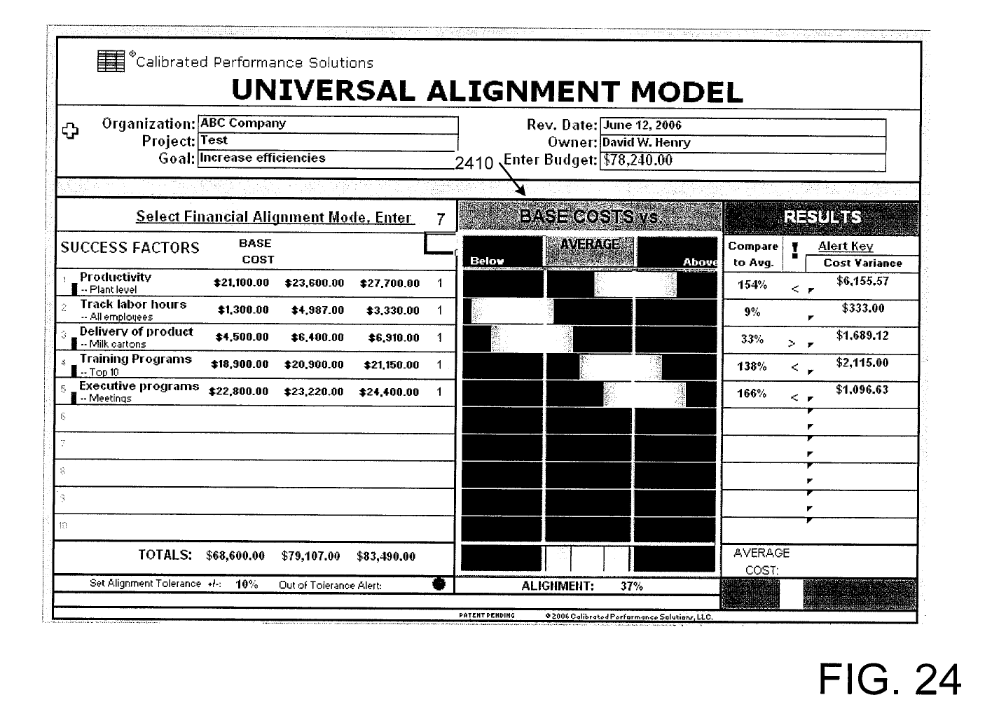

FIG. 24 is an exemplary user interface illustrating a calculation of base success factor performance versus an average base performance, similar to the user interface from FIG. 23.

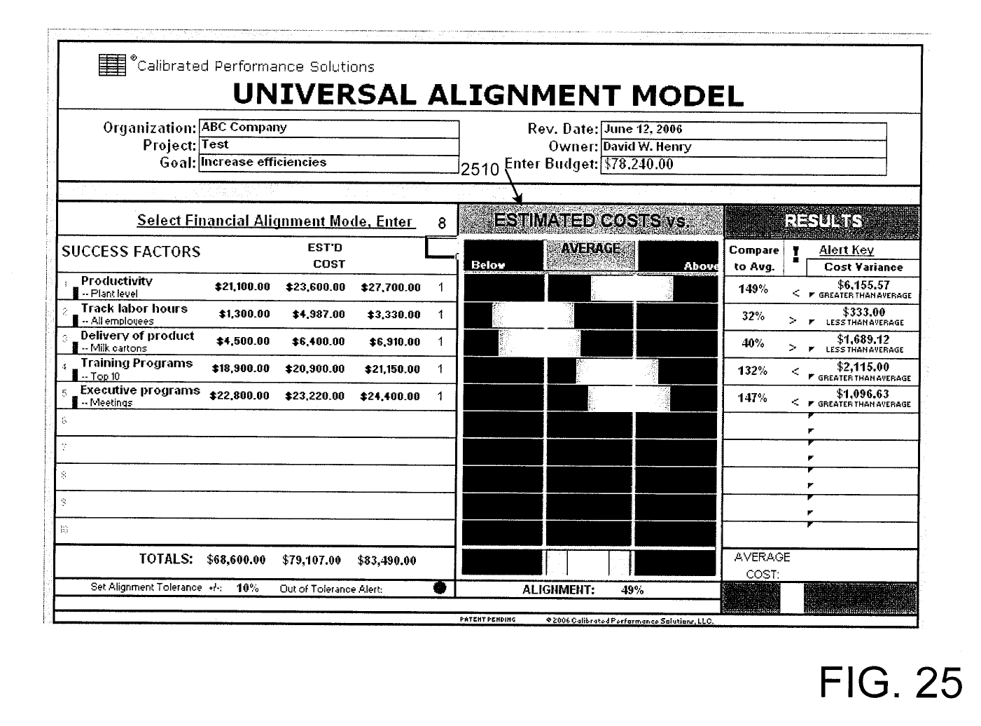

FIG. 25 is an exemplary user interface illustrating a calculation of estimated success factor performance versus average estimated performance of all success factors, similar to the user interface from FIG. 24.

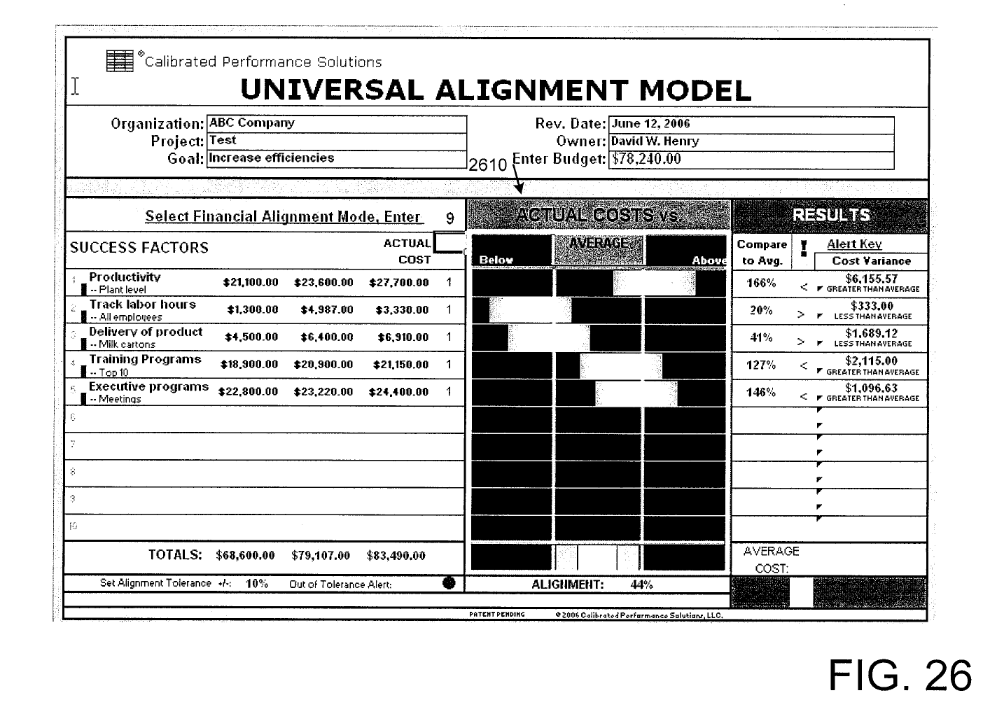

FIG. 26 is an exemplary user interface illustrating a calculation of actual success factor performance versus average performance of a plurality of success factors, similar to the user interface from FIG. 25.

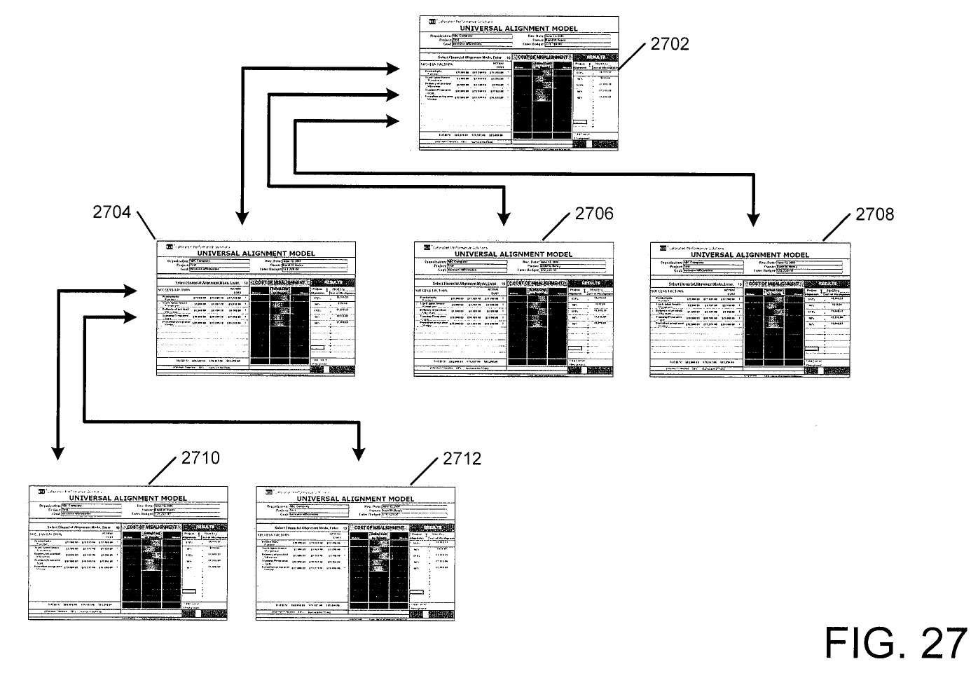

FIG. 27 is a diagram illustrating exemplary relationships between a plurality of user interfaces, similar to the user interfaces from FIGS. 18-26.

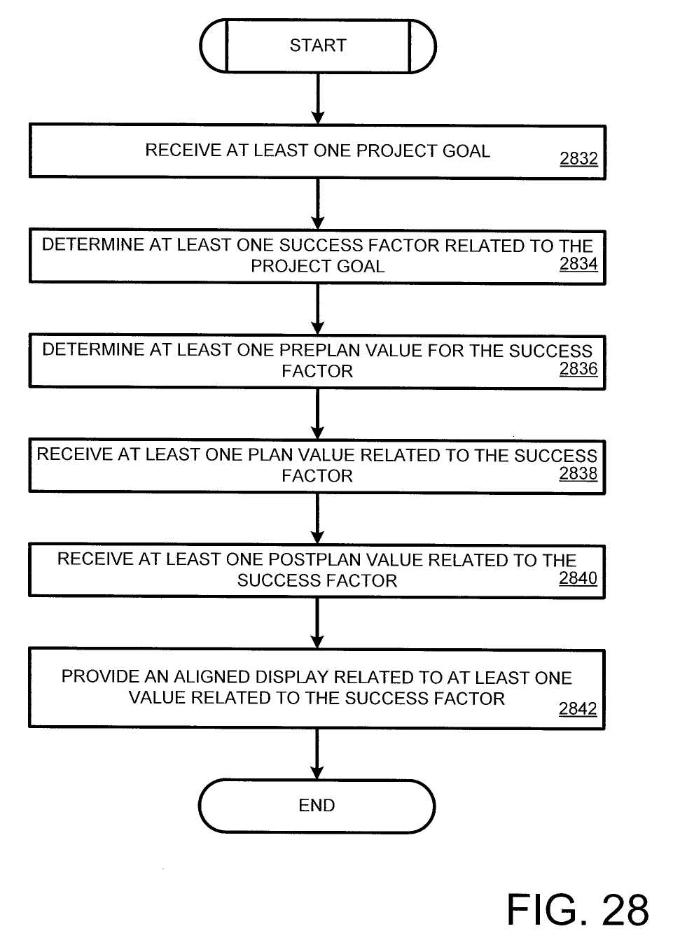

FIG. 28 is a flowchart illustrating an exemplary process that can be utilized for creation of an alignment model based on at least one project goal, such as the model from FIG. 3.

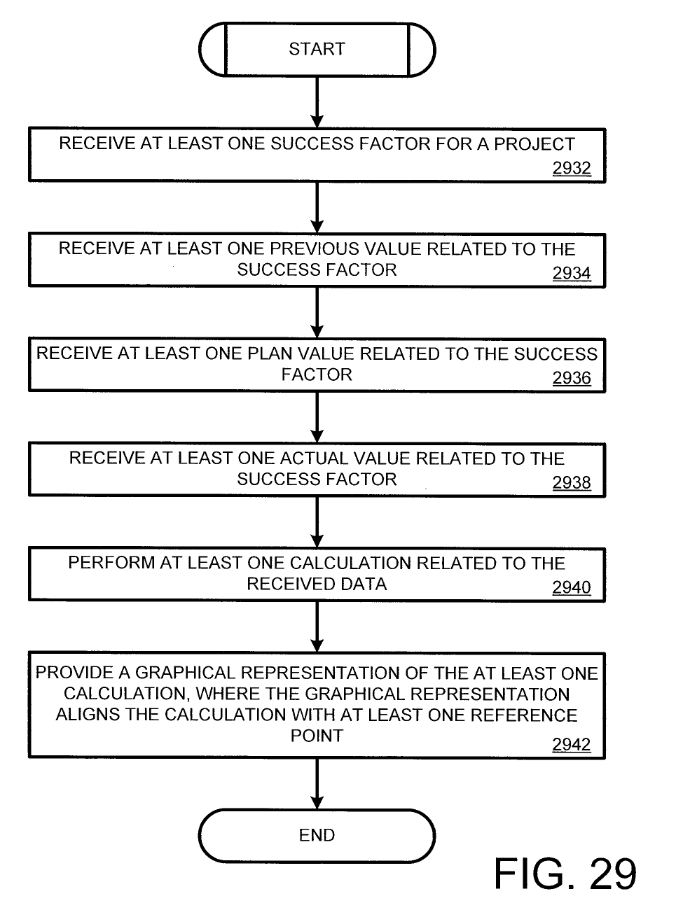

FIG. 29 is a flowchart illustrating a process that can be utilized for calculating alignment of data related to at least one success factor, such as a success factor illustrated in FIG. 3.

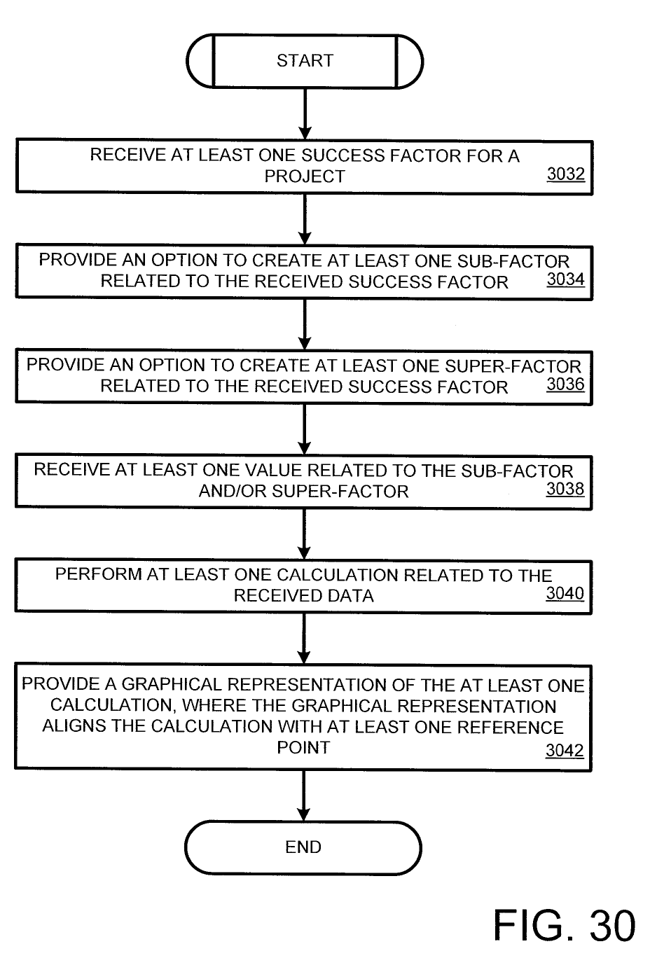

FIG. 30 is a flowchart illustrating a process that can be utilized for utilizing one or more sub-factor and/or super-factor of a success factor, similar to the flowchart from FIG. 29.

### DETAILED DESCRIPTION

A performance alignment model can be configured to provide individuals and/or organizations with a process for setting a project goal, defining success factors to achieve the goal, assigning relative weights to the success factors, and selecting from various alignment modes to track, and tracking performance of the success factors. The performance alignment model can also be configured to ascertain a degree of alignment related to one or more of the success factors, and capture project performance alignment data for future reference.

FIG. 1 is a functional diagram of an exemplary communications network environment that can be utilized to provide a performance alignment model to one or more users. As illustrated, a plurality of users may be connected via an external network such as communications network 100. Communications network 100 can include, for example, the Internet, a Wi-Fi® network (IEEE 802.11 compatible), a Wi-Max network (IEEE 802.16 compatible), a Public Switched Telephone Network (PSTN), a cellular communications network and/or other communications mediums. The users may access the communications network 100 via client devices 106a, 106b, 106c, and/or client device 106d (via wireless access point 104). The client devices may include, for example, portable communication device 106d, a personal computer 106a, 106c, and/or other communication devices 106b. It should be appreciated that while network 100, client devices 106, and connections illustrated in FIG. 1 are shown by way of example, this disclosure is not limited to these examples. The disclosure may be applicable to any client device, connection, and network that supports voice, data, and/or other types of communications.

Depending on the type of communication desired, different functionality may be utilized. More specifically, while client devices 106a and 106b may be configured to facilitate voice communications over a cellular network and/or a PSTN, they may also be configured for data communications via the Internet. Additionally, client devices 106 may also be configured to facilitate communications via a Wi-Fi® network and/or a Wi-Max network. As a nonlimiting example, if a user operating client device 106 wishes to make a cellular communication, the user can input the address (e.g., telephone number) of the callee device. This address can be sent to the wireless access point 104 (which may include a cellular antenna and/or other component), configured to send the communication request to network 100. Network 100 may employ one or more cellular networks, PSTNs and/or other networks for facilitating the communication. Upon connecting client device 106 with the callee device, communication may begin.

Similarly, if a user operating client device 106 wishes to access a website (and/or other data associated with the Internet), the user can send a communication request, which may include an address, such as a Uniform Resource Locator (URL). The request can be sent to the desired computing device via network 100, which may include the Internet, a Wi-Max network and/or a Wi-Fi® network. The desired computing device can then respond by sending the requested data to the client device 106b via the same (or similar) transmission mediums, as a nonlimiting example.

FIG. 2 is a functional diagram illustrating an exemplary embodiment of a client device that may be configured to communicate via a communications network such as the network from FIG. 1. Although a wire-line client device is illustrated, other computing devices, such as a mobile telephone, a portable telephone, a wireless personal computer, a PDA, a blackberry, an IPOD, etc., can also be considered within the scope of this discussion. Generally, in terms of hardware architecture, as shown in FIG. 2, a client device 106 may include a processor 282, volatile and/or nonvolatile memory 284, a display interface 294, data storage 295, one or more input and/or output (I/O) device interface(s) 296, and/or one or more network interfaces 298 that are communicatively coupled via a local interface 292. The local interface 292 can include, for example but not limited to, one or more buses or other wired or wireless connections. The local interface 292 may have additional elements, which are omitted for simplicity, such as controllers, buffers (caches), drivers, repeaters, and receivers to enable communications. Further, the local interface may include address, control, and/or data connections to enable appropriate communications among the aforementioned components. The processor 282 may be a hardware device for executing software, particularly software stored in volatile and nonvolatile memory 284.

The processor 282 can be any custom made or commercially available processor, a central processing unit (CPU), an auxiliary processor among several processors associated with the client device 106, a semiconductor based microprocessor (in the form of a microchip or chip set), a macroprocessor, or generally any device for executing software instructions.

The volatile and nonvolatile memory 284 can include any one or combination of volatile memory elements (e.g., random access memory (RAM, such as DRAM, SRAM, SDRAM, etc.)) and nonvolatile memory elements (e.g., ROM, hard drive, tape, CDROM, etc.). Moreover, the memory 284 may incorporate electronic, magnetic, optical, and/or other types of storage media. One should note that the volatile and nonvolatile memory 284 can have a distributed architecture (where various components are situated remote from one another), but can be accessed by the processor 282. Additionally volatile and nonvolatile memory 284 can include communications software (not shown), alignment logic 299, and/or an operating system 286.

The software in volatile and nonvolatile memory 284 may include one or more separate programs, each of which includes an ordered listing of executable instructions for implementing logical functions. In the example of FIG. 2, the software in the volatile and nonvolatile memory 284 may include communications software (which can include instant messaging software, email software, web browsing software, telephony software, etc. in one or more separate software packages), as well as operating system 286. The operating system 286 can be configured to control execution of other computer programs and provides scheduling, input-output control, file and data management, memory management, and communication control and related services. Also included is alignment software 299 (which may take the form of software, hardware, and/or other forms of logic). Alignment software 299 may be accessed via a computing device 106 illustrated in FIG. 2 and may be stored locally on computing device 106 and/or accessed via the network of FIG. 1. Alignment software 299 is described in more detail below.

A system component and/or module embodied as software also may be construed as a source program, executable program (object code), script, or any other entity comprising a set of instructions to be performed. When constructed as a source program, the program may be translated via a compiler, assembler, interpreter, or the like, which may or may not be included within the volatile and nonvolatile memory 284, so as to operate properly in connection with the operating system 286.

The Input/Output devices that may be coupled to system I/O Interface(s) 296 may include input devices, for example but not limited to, a keyboard, mouse, scanner, etc. Further, the Input/Output devices may also include output devices, for example but not limited to, a printer, display, speaker, etc. Finally, the Input/Output devices may further include devices that communicate both as inputs and outputs, for instance but not limited to, a modulator/demodulator (modem; for accessing another device, system, or network), a radio frequency (RF) or other transceiver, a telephonic interface, a bridge, a router, etc.

Additionally included are one or more network interfaces 298 for facilitating communication with one or more other devices. More specifically, network interface 298 may include one or more components configured to facilitate a connection with another device. While in some embodiments, among others, the client device 106 can include a network interface 298 that includes a Personal Computer Memory Card International Association (PCMCIA) card (also abbreviated as “PC card”) for receiving a wireless network card, however this is a nonlimiting example. Other configurations can include the communications hardware within the computing device, such that a wireless network card is unnecessary for communicating wirelessly. Similarly, other embodiments include network interfaces 298 for communicating via a wired connection. Such interfaces may be configured with Universal Serial Bus (USB) interfaces, serial ports, and/or other interfaces.

If the client device 106 is a personal computer, workstation, or the like, the software in the volatile and nonvolatile memory 284 may further include a basic input output system (BIOS) (omitted for simplicity). The BIOS is a set of software routines that initialize and test hardware at startup, start the operating system 286, and support the transfer of data among the hardware devices. The BIOS is stored in ROM so that the BIOS can be executed when the client device 106 is activated.

When the client device 106 is in operation, the processor 282 may be configured to execute software stored within the volatile and nonvolatile memory 284, to communicate data to and from the volatile and nonvolatile memory 284, and to generally control operations of the client device 106 pursuant to the software. Software in memory, in whole or in part, may be read by the processor 282, perhaps buffered within the processor 282, and then executed.

FIG. 3 is an exemplary user interface illustrating alignment of base performance data, which may be provided by the computing device from FIG. 2. As illustrated in this nonlimiting example, interface 300 may include an organization field 302, a project field 304, a goal field 306, a date field 308, and an owner field 314. The organization field 302 can be configured to receive a user-defined organization that is associated with the current project. This data can be manually entered by a user and/or entered during a setup process by an organization administrator. As such, the organization field 302 may be configured to default to one or more predetermined organizations. Project field 304 can be configured to receive a title for the current project. Again, this data can be entered by a user and may be consistent through a plurality of user interfaces of the current project. The goal field 306 may also be input by a user and, depending on the particular configuration, may be selected from a predetermined group of goals and/or created by a user.

More specifically, in at least one nonlimiting example, the goal field 306 may include a menu (e.g., a dropdown menu) for a user to select one or more goals for the current project. Upon selecting a goal, the alignment logic 299 can be configured to provide one or more success factors from which a user can select for the current project and/or goal. Additionally, in some embodiments, the user can supplement the provided success factors with user-defined success factors. Similar to the configuration described above, in at least one embodiment, the user can define at least one goal associated with a project. In such an embodiment, the user can then create one or more success factors and/or select at least one success factor from a predetermined list of potential success factors.

Similar to goal field 306, date field 308 can be automatically populated by the alignment logic 299 and/or input by a user. Similarly, the user can input data into the owner field 310 and/or this data can be provided by the alignment logic 299.

As discussed above, one or more success factors 314-322 can be included in the interface display 300. In the nonlimiting example of FIG. 3, success factors include productivity 314, labor hours 316, delivery of product 318, training programs 320, and executive programs 322. The success factors can be created by a user and/or selected based on the current project and/or goal.

Additionally included are columns 324, 326, and 328. More specifically, as illustrated, one or more of the success factors 314-322 can be associated with a base or “preplan” value 324, a “plan” value 326, and an actual or “postplan” value 328. The preplan value 324 can be configured to indicate at least one value associated with a success factor before a plan was utilized. More specifically, in interface 300, the productivity count before a plan was utilized amounted to 34 units. Similar values are illustrated in column 324 for the other success factors 316-322. The data in column 324 can be input by a user and/or accessed by the alignment logic 299 from a local location, from a remote location, and/or from another location, as illustrated in FIGS. 1 and 2.

Additionally included in interface 300 is a “plan” column 326. “Plan” column 326 can include one or more target values associated with the one or more success factors. The target values can be entered by a user and/or calculated and provided by the alignment logic 299. More specifically, in at least one nonlimiting example, the alignment logic 299 can determine a “plan” value for one or more of the success factors based on the goal entered in goal field 306 and/or other factors. The alignment logic 299 can make the calculations, which, depending on the particular configuration, can be modified by a user. As illustrated in FIG. 3, the plan data 326 associated with productivity success factor 314 is 45 units. This means that for the particular project, ABC Company has a target to produce 45 units for a predetermined amount of time (which can be determined by a user and/or determined by alignment logic 299).

“Postplan” column 328 can be configured to provide values related to performance of the success factors following implementation of the plan. As discussed above, prior to implementation of the plan, productivity success factor 314 yielded ABC Company 34 units. The implemented plan dictates a productivity value of 45 units. Since implementation of the plan, the productivity value has reached 55 units, as indicated in column 328.

Additionally included in interface 300 is a base alignment display 329. As illustrated, the base alignment display 329 can include a plurality of columns 330, 332, 334 that can be configured to indicate various data related to the preplan, plan, postplan data and/or other data, in an aligned configuration. As a nonlimiting example, the productivity success factor 314 is associated with status indicator 338. Track labor hours success indicator 316 is associated with status indicator 340. Delivery of product success factor 318 is associated with status indicator 342. Training programs success factor 320 is associated with status indicator 344. Executive programs success factor 322 is associated with status indicator 346. As illustrated in display 329, status indicators 338-346 are configured in relative alignment with the center position (optimal 100% alignment) to illustrate the relative value of base preplan values 324 associated with one or more of the success factors 314-322. More specifically, as productivity success factor 314 has a preplan value of 34, delivery of product success factor 318 has a preplan value of 22. As such, status indicator 338 is aligned to the right of status indicator 342.

One should also note that embodiments may also include a weighting value for each success factor relative to the other success factors. In at least one of these embodiments, the default weight is 1 for a success factor, however the weights can be changed to other values if desired. Additionally, embodiments may include a drop-down selection of various alignment modes by which to track performance of data; the selected alignment mode is displayed at the top of display 329.

FIG. 4 is an exemplary user interface illustrating alignment of plan performance data, similar to the interface from FIG. 3. As illustrated in this nonlimiting example, plan data 326 is displayed in plan alignment display 429 for success factors 314-322. Similar to the configuration from FIG. 3, plan alignment display 429 illustrates an aligned display of one or more of the success factors, with respect to plan values from column 326. More specifically, plan alignment display 429 is currently displaying a status indicator 438, which is associated with a plan value for productivity success factor 314. Similarly, executive success factor has a plan value of 89% and is associated with status indicator 446. As the plan value for productivity success factor 314 has a value of 45 and executive success factor 322 has a plan value of 89%, status indicator 446 is aligned to the right of status indicator 438. Similar display for status indicators 440-444 are similarly displayed in FIG. 4. Additionally, status indicator 448 is included to illustrate an overall alignment of plan data for the success factors displayed in FIG. 4. The alignment position of status indicator 448 indicates the cumulative alignment position of all success factors with respect to the center position, and the yellow band within indicates the cumulative alignment of all success factors with respect to the success factors themselves.

Additionally included in the nonlimiting example of FIG. 4 is a results display 450. Results display 450 may be configured to determine whether one or more of the success factors are misaligned according one or more goals. More specifically, as a user may determine the plan values, alignment logic 299 can be configured to provide an alert if the user defined plan values are not acceptable for the current plan.

FIG. 5 is an exemplary user interface illustrating alignment of actual performance data, similar to the interface from FIG. 4. As illustrated in this nonlimiting example, result alignment display 529 includes one or more status indicators 538-548 that may be configured to represent a value from postplan section 328 for a success factor 314-322. More specifically, labor hours success factor 316 has a postplan value of 90%. Delivery of product success factor has a postplan value of 56%. As such, status indicator 540 is aligned slightly to the right of status indicator 542. Additionally included in the nonlimiting example of FIG. 5 is a results display 550, which may be configured to indicate when a value is beyond a predetermined threshold.

FIG. 6 is an exemplary user interface illustrating an alignment comparison of base performance data and plan performance data, similar to the interface from FIG. 5. As illustrated in this nonlimiting example, comparison display 629 includes a plurality of status indicators 638-646 that indicate a comparison between base section 324 and plan comparison 326. More specifically, in this nonlimiting example, data from plan column 326 is displayed with base value 324 as a reference for the success factors. More specifically, with regard to productivity success factor 314, a reference point (which is located substantially central in display 629) is associated with a value of 34 counts. As the plan calls for 45 counts of productivity, status indicator 638 is located to the right of the reference point. Similarly, preplan value 324 for labor hours success factor 316 is utilized in display 629 as a reference point for plan data 326. As plan data 326 has a value of 100 (versus 116 for base value 324), status indicator 640 is located left of the center of display 629. Similar configurations are displayed for success factors 318-322.

Similarly, results display 650 includes a plurality of alerts to indicate whether data in display 629 is aligned. More specifically, with respect to productivity success factor 314, results display 650 indicates that plan data (45 count) has achieved a calculated score of 132% in relation to base data 324. Results display 650 then indicates one or more steps to align base value 324 with plan value 326.

FIG. 7 is an exemplary user interface illustrating an alignment comparison of base performance data and actual performance data, similar to the interface from FIG. 6. As illustrated in this nonlimiting example, display 729 includes a plurality of status indicators 738-746. Status indicators 738-746 are configured to indicate a result value 328 compared to a base value 324. More specifically, the delivery of product success factor 318 has an associated postplan value of 56%. The delivery of product success factor 318 also has an associated preplan value of 22%. Because the postplan value of 56% is greater than the preplan value of 22%, status indicator 742 is aligned on the right side of results display 729. Similarly, results display 750, in this nonlimiting example, indicates that this success factor can be decreased to match the postplan value 328 and the preplan value 324.

FIG. 8 is an exemplary user interface illustrating an alignment comparison of plan performance data and actual performance data, similar to the interface from FIG. 7. As illustrated in this nonlimiting example, result display 829 includes a plurality of status indicators 838-846 and provides an aligned display of postplan data 328 and plan data 326. More specifically, executive success factor 322 has a plan value of 89% and a postplan value of 85%. As plan data is used as a reference point in this nonlimiting example and the postplan data is less than plan data, status indicator 846 is aligned to the left of the center of display 829. Similarly, results display 850 indicates that postplan data is only 96% of plan data and that the postplan data can be increased.

FIG. 9 is an exemplary user interface illustrating an alignment comparison of base performance data and average base performance data, similar to the interface from FIG. 8. As illustrated in this nonlimiting example, base values 324 associated with the success factors are compared to an average base value in display 929 and displayed with status indicators 938-946. As a nonlimiting example, the base value of productivity success factor 314 is 34 counts. This value is compared to an average base value for productivity, which is used as a reference point. As illustrated, the base value of 34 is less than the reference point, and thus status indicator 938 is positioned on the left side of base display 929. Similarly, results display 950 indicates that productivity base value is only 51% of the average.

FIG. 10 is an exemplary user interface illustrating an alignment comparison of plan performance data and average plan performance data, similar to the interface from FIG. 9. As illustrated in this nonlimiting example, plan data 326 is compared with average plan data and displayed with status indicators 1038-1046 in plan display 1029. More specifically, as a nonlimiting example, success factor training programs 320 has a plan value of 50%. This value is compared with an average plan value that is used as a reference point. As 50% is less than the average plan value for training programs, status indicator 1044 is aligned on the left side of display 1029. Similarly, results display 1050 indicates that plan value for training programs is 76% of the average and that this success factor can be increased to match the average.

FIG. 11 is an exemplary user interface illustrating an alignment comparison of actual performance data and average actual performance data, similar to the interface from FIG. 10. As illustrated in this nonlimiting example, postplan data 328 is compared with average postplan data for the success factors 314-322 and displayed with status indicators 1138-1146. More specifically, as a nonlimiting example, labor hours success factor 316 has a postplan value of 90%. As illustrated in results display 1129, this is greater than the average postplan value, and thus status indicator 1140 is aligned to the right of results display 1129. Similarly, results display 1150 indicates that the labor hours postplan value of 90% is 136% of the average postplan data and that this value can be decreased to match the average.

FIG. 12 is an exemplary user interface illustrating an alignment representation of base performance data, rated from 0% to 100% (optimal alignment), but otherwise similar to the interface from FIG. 10. As illustrated in this nonlimiting example, productivity success factor 314 has a base value of 34 counts. Base display 1229 illustrates, with status indicator 1238 that this value is slightly less than 50% of a predetermined maximum value. Similar indications are made with status indicators 1240-1246.

FIG. 13 is an exemplary user interface illustrating an alignment representation of plan performance data, similar to the interface from FIG. 12. As illustrated in this nonlimiting example, plan data is compared with a calculated maximum value for a success factor. More specifically, delivery of product success factor 318 has a plan value of 45%. As this value is less than 50% of a predetermined maximum of 100%, status indicator 1342 is aligned to the left side of display 1329.

FIG. 14 is an exemplary user interface illustrating an alignment representation of actual performance data, similar to the interface from FIG. 13. As illustrated in this nonlimiting example, postplan data is compared to a calculated maximum value and displayed with status indicators 1438-1448 in display 1429. More specifically, executive success factor 322 has a postplan value of 85%. This value is compared to a predetermined maximum value of 100%, and provided in display 1429. As 85% is more than the medium predetermined value of 50%, status indicator 1436 is aligned on the right side of display 1429.

FIG. 15 is an exemplary user interface illustrating a bar graph representation of base performance data, similar to the interface from FIG. 14. As illustrated in this nonlimiting example, preplan values are provided in display 1529 as a bar graph representation. More specifically, productivity success factor 314 is associated with a preplan value of 34. This value is illustrated with status indicator 1538. Similar representations may be made for other success factors with status indicators 1540-1546.

FIG. 16 is an exemplary user interface illustrating a bar graph representation of plan performance data, similar to the interface from FIG. 15. As illustrated in this nonlimiting example, status indicators 1638-1646 are displayed in a bar graph representation for plan data associated with a plurality of success factors 314-322. More specifically labor hours 316 has a plan value of 100%. This data is provided in display 1629 with status indicator 1640. Similar representations may be made for other success factors 314 and 316-322, with status indicators 1638 and 1642-1646.

FIG. 17 is an exemplary user interface illustrating a bar graph representation of actual performance data, similar to the interface from FIG. 16. As illustrated in this nonlimiting example, training programs success factor 320 has a postplan value of 45%. As such, status indicator 1744 in display 1729 represents 45% of a predetermined maximum value. Similarly, status indicators 1738-1742 and 1746 indicate similar data with respect to success factors 314-318 and 322.

One should note that the aligned representations discussed with regard to FIGS. 3-17 are nonlimiting examples. More specifically, while the representations in FIGS. 3-17 illustrate rectangular status identifiers, other sizes and shapes of indicators may be utilized. Similarly, one should also note that while the nonlimiting examples from FIGS. 3-17 illustrate a configuration where each success factor has a reference point that is independent of other success factors, this is a nonlimiting example, as groups of success factors can be grouped together with a common reference point.

FIG. 18 is an exemplary user interface illustrating alignment of a plurality of factors, which may be displayed on the computing device from FIG. 2. Similar to the nonlimiting example from FIG. 3, interface 1800 includes an organization field 1802, a project field 1804, a goal field 1806, a revision date field 1808, an owner field 1810 and a budget field 1812. The organization field 1802 can be configured to receive a user-defined organization that is associated with the current project. This data can be manually entered by a user and/or entered during a setup process by an organization administrator. As such, the organization field may be configured to default to one or more predetermined organizations. Project field 1804 can be configured to receive a title of the current project. Again, this data can be entered by a user and may be consistent through a plurality of user interfaces of the current project. The goal field 1806 may also be input by a user and, depending on the particular configuration, may be selected from a group of goals and/or created by a user.

More specifically, in at least one nonlimiting example, the goal field 1806 may include a menu (e.g., a dropdown menu) for a user to select one or more goals for the current project. Upon selecting a goal, the alignment logic 299 can be configured to provide one or more success factors from which a user can select for the current project and/or goal. Additionally, in some embodiments, the user can supplement the provided success factors with user-defined success factors.

Also similar to FIG. 3, the user can define at least one goal associated with a project. In such an embodiment, the user can then create one or more success factors and/or select at least one success factor from a predetermined list of potential success factors. The revision date 1808 field can be automatically populated by the alignment logic 299 and/or input by a user. Similarly, the user can input data into the owner field 1810 and/or this data can be provided by the alignment logic 299. The budget field 1812 can be entered by a user, configured by the alignment logic 299, and/or selected from a dropdown menu.

As discussed above, one or more success factors 1814-1822 can be included in the interface display 1800. In the nonlimiting example of FIG. 18, success factors include productivity 1814, labor hours 1816, delivery of product 1818, training programs 1820, and executive programs 1822. The success factors can be created by a user and/or selected based on the current project and/or goal. Additionally included are columns 1824, 1826, and 1828. More specifically, as illustrated, one or more of the success factors 1814-1822 can be associated with a “preplan” or “base” value 1824, a “plan” or “estimated” value 1826, and a “postplan” or “actual” value 1828. The preplan value 1824 can be configured to indicate at least one value associated with a success factor before a plan was utilized. More specifically, in interface 1800, the productivity costs before a plan was utilized amounted to $21,100.00. Similar values are illustrated in column 1824 for the other success factors 1816-1822. The data in column 1824 can be input by a user and/or accessed by the alignment logic 299 from a local location, from a remote location, and/or from another location.

Additionally included in interface 1800 is a “plan” column 1826, in this nonlimiting example. “Plan” column 1826 can include one or more target values associated with one or more success factors. The target values can be entered by a user and/or calculated and provided by the alignment logic 299. More specifically, in at least one nonlimiting example, the alignment logic 299 can determine a “plan” value for one of more of the success factors based on the goal entered in goal field 1806 and/or other factors. The alignment logic 299 can make the calculations, which, depending on the particular configuration, can be modified by a user.

The “postplan” column 1828 can be configured to provide values related to performance of the success factors following implementation of the plan. As illustrated in interface 1800, prior to implementation of the plan, productivity success factor 1814 cost ABC company $21,100.00. The plan implemented indicated a target productivity cost of $23,600.00. Implementation of the plan results in an actual productivity cost of $27,700.00, as indicated in column 1828.

Additionally included in interface 1800 is a cost of misalignment display 1829, in this nonlimiting example. As illustrated, the cost of misalignment can include a plurality of columns 1830, 1832, 1834 that can be configured to indicate various data related to the preplan, plan, and postplan data (and/or other data) in an aligned configuration. As a nonlimiting example, the productivity success factor 1814 is associated with status indicator 1838. Track labor hours success indicator 1816 is associated with status indicator 1840. Delivery of product success factor 1818 is associated with status indicator 1842. Training programs success factor 1820 is associated with status indicator 1844. Executive programs success factor 1822 is associated with status indicator 1846.

Additionally included in the nonlimiting example of FIG. 18 is a results display 1848. Results display 1848 may be configured to determine whether one or more of the success factors are misaligned according to an alignment tolerance 1836. Tolerance 1836 may be user-defined, however this is not a requirement, as in at least one embodiment, tolerance 1836 can be determined by alignment logic 299. If one or more of the success factors are misaligned beyond the tolerance 1836, results display 1848 can provide an alert that indicates the degree of misalignment and the cost of misalignment. One should also note that, depending on the particular configuration, a tolerance can also be utilized in the nonlimiting examples of FIGS. 3-17.

More specifically, the nonlimiting example of FIG. 18 illustrates the cost that the project incurs by being out of alignment with the project goal. Following implementation of the project plan, the resulting alignment and actual cost of one or more of the success factors can be determined. The cost of misalignment may be a function of the degree of misalignment and actual cost. As a nonlimiting example, the performance logic 299 can be configured to calculate productivity success factor alignment to be 122% or 22% in excess of the goal. Performance alignment above 100% indicates use of resources in excess of the business need and may represent an unnecessary cost. Success factor alignment below 100% indicates deficient performance and thereby represents additional cost to bring that performance into alignment with the goal. In FIG. 27, the logic can be configured to calculate the cost of misalignment as a function of the 22% performance in excess of the business desire and the actual cost of that success factor when the plan is implemented. As a nonlimiting example, productivity may have an alignment score of 122% and an actual cost of $27,700. The cost of misalignment is 22%, multiplied by $27,700, to provide a result of $6,094.

FIG. 19 is an exemplary user interface illustrating estimated costs related to a plurality of factors, similar to the user interface from FIG. 18. As illustrated in the nonlimiting example of FIG. 19, success factors 1814-1822, preplan column 1824, plan column 1826, and postplan column 1828 include the same data as illustrated in FIG. 18. However, this nonlimiting example includes a planned performance display 1910 that can be configured to provide a graphical depiction of planned performance data (plan data) from column 1826. Other data may also be displayed.

One should note that while the estimated cost display 1910 illustrates the estimated cost data as a bar graph, this is a nonlimiting example, as other displays are also considered. More specifically, at least one embodiment can provide a pie chart, line graph, and/or other display.

FIG. 20 is an exemplary user interface illustrating actual costs related to a plurality of factors, similar to the user interface from FIG. 19. As illustrated in this nonlimiting example, actual costs display 2010 can be derived from success factor data 1814-1828, as described above. However, in this configuration, a display of actual (postplan) cost from column 1828 is displayed. As discussed above, while this data can be displayed as a left-justified bar graph, this is a nonlimiting example, as other displays may also utilized.

FIG. 21 is an exemplary user interface illustrating a comparison of estimated coast to base cost, similar to the user interface from FIG. 20. As illustrated in the nonlimiting example of FIG. 21, success factor data 1814-1828 is included, as discussed above. However, in this nonlimiting example, planned cost versus base cost display 2110 is also included. More specifically, estimated cost versus base cost display 2110 can be configured to display preplan column 1824 against plan column 1826 in an aligned manner. In display 2110, estimated cost column 1826 (along with tolerance 1836) is displayed as vertical lines for an aligned display. Status indicators 2138-2146 are positioned, based on the base cost data from column 1824 to indicate whether a particular success factor is aligned with respect to the data in estimated cost column 1826.

Depending on the particular embodiment, vertical lines defining the “alignment optimal” portion of display 2110 (and/or in other drawings discussed in this disclosure) can be configured in any of a plurality of different ways. More specifically, in at least one nonlimiting example, the vertical lines can be spaced such that status indicators 2138-2146 fit within “alignment optimal” portion of display 2110, with little or no space between the edges of the status indicator 1838-1846 and the vertical lines. Other embodiments can be configured to space vertical lines such that tolerance 1836 is accounted. More specifically, such an embodiment can be configured to space vertical lines such that there is space for status indicator 1838-1846 to remain within the alignment optimal section of display 2110, when base performance is within the tolerance 1836.

As a nonlimiting example from FIG. 21, tolerance 1836 is set at 10%. As such, vertical lines defining “alignment optimal” section of display 2110 can be configured such that as long as base cost 1824 is within 10% of estimated cost 1826, for a particular success factor, the corresponding status indicator can fully fit within the alignment optimal portion of display 2110. Other configurations are also considered as part of this disclosure.

FIG. 22 is an exemplary user interface illustrating a comparison of actual cost and base cost, similar to the user interface from FIG. 21. As illustrated in this nonlimiting example, actual cost versus base cost display 2210 can be configured to provide an aligned display of base cost data 1824 with actual cost data 1828. While in this nonlimiting example, base cost 1824 defines vertical lines of display 2210 and actual cost 1828 defines status indicators, this is a nonlimiting example, as other configurations are also included within the scope of this disclosure.

FIG. 23 is an exemplary user interface illustrating a comparison of actual cost and planned cost, similar to the user interface from FIG. 22. As illustrated in this nonlimiting example, display 2310 can be configured to provide an aligned display of actual cost data 1828 versus estimated cost data 1826. The graphical representation of this data can provide a user with the ability to modify and/or select a new success factor for optimal project cost.

FIG. 24 is an exemplary user interface illustrating a calculation of base cost versus an average base cost, similar to the user interface from FIG. 23. As illustrated in this nonlimiting example, base cost data (preplan data) 1824 can be compared against an average cost for a particular success factor and provided in display 2410. The average can be calculated as an average cost of all success factors in a project, as well as from any number of other data including historical averages, competitor averages, etc.

FIG. 25 is an exemplary user interface illustrating a calculation of estimated costs versus an average estimated cost, similar to the user interface from FIG. 24. As illustrated in this nonlimiting example, display 2510 can be configured to provide an aligned display of estimated costs (plan data) 1826 versus an average estimated cost for one or more of the success factors. Similar to the nonlimiting example of FIG. 24, this interface can be configured to receive average data from any number of different sources.

FIG. 26 is an exemplary user interface illustrating a calculation of actual costs versus average actual costs, similar to the user interface from FIG. 25. As illustrated in the nonlimiting example of FIG. 26, display 2610 can be configured to provide an aligned display of actual cost (postplan data) versus an average actual cost. As discussed above, the average data can include current and/or historical data for this organization, and/or other organizations.

FIG. 27 is a diagram illustrating exemplary relationships between a plurality of user interfaces, similar to the user interfaces from FIGS. 18-26. One or more of the success factors can be expanded into its own cost alignment model, whereby its cumulative alignment score may become the value for that success factor. More specifically, in at least one embodiment, one or more success factors can include one or more success sub-factors and/or success super-factors. As a nonlimiting example, in creating the model from FIGS. 18-26 (illustrated as element 2702 in FIG. 27), a determination can be made that productivity 1814 includes the sub-factors “hours worked” and “amount produced.” As such, to more accurately track productivity 1814, “hours worked” and “amount produced” may also be tracked in user interface 2704. Upon receipt and analysis of “hours worked” and “amount produced,” productivity can be determined and utilized in 2702.

Similarly, a user may create a model in user interface 2706. This model may be configured such that one or more of the success factors in user interface 2706 (and/or overall analysis) apply as a success factor in user interface 2702. As a nonlimiting example, a user may create a plan for achieving a goal. Before, during, or after creation of user interface 2706, the user may realize that the factors of interface 2706 are actually related to a super-factor, such as in interface 2702. Consequentially, user interfaces 2702 and 2706 can be linked, such that upon calculation and/or analysis of the data from user interface 2706, data in user interface 2702 can be populated accordingly.

Similar relationships between independently created models, as illustrated with models 2708, 2710, and 2712. These models can be created to provide a relationship with one or more other models, as a nonlimiting example. More specifically, in at least one nonlimiting example, one or more of the models can be created without knowledge of another model. A relationship can be established at a subsequent time, such that communication of data between the models is facilitated.

FIG. 28 is a flowchart illustrating an exemplary process that can be utilized for creation of an alignment model based on at least one project goal, such as the model from FIG. 18. As illustrated in the nonlimiting example of FIG. 28, alignment logic 299 can be configured to receive at least one project goal (block 2832). As discussed above, the at least one project goal can be created by a user and/or selected from a predetermined list that may be provided by the alignment logic 299. Upon determining the project goal, the alignment logic can be configured to determine at least one success factor related to the project goal (block 2834). This determination can result from receiving user input, however this is not a requirement. The alignment logic 299 can then determine at least one preplan value for the success factor (block 2836). The alignment logic 299 can then determine at least one plan value for at least one success factor (block 2838). After implementation of the plan, the alignment logic can determine at least one postplan value for at least one success factor (block 2840). The alignment logic can then calculate and display the degree of alignment to the goal of least one value related to the success factor (block 2842).

FIG. 29 is a flowchart illustrating a process that can be utilized for aligning data related to at least one success factor, such as a success factor illustrated in FIG. 3. More specifically, as illustrated in FIG. 29, the alignment logic 299 can be configured to receive at least one success factor for a project (block 2932). The alignment logic 299 can then receive at least one previous value related to at least one success factor (block 2934). Next, the alignment logic 299 can receive at least one plan value related to the success factor (block 2936). The alignment logic 299 can then receive at least one actual value related to the success factor (block 2938). The alignment logic 299 can then perform at least one calculation related to the received data (block 2940). The alignment logic can then provide a graphical representation of the at least one calculation, where the graphical representation aligns the calculation with at least one reference point (block 2942).

FIG. 30 is a flowchart illustrating a process that can be utilized for utilizing one or more sub-factor and/or super-factor of a success factor, similar to the flowchart from FIG. 29. As illustrated in the nonlimiting example of FIG. 30, alignment logic 299 can be configured to receive at least one success factor for a project (block 3032). The alignment logic 299 can then provide an option to create at least one sub-factor related to the received success factor (block 3034). Next, the alignment logic 299 can provide an option to create at least one super-factor related to the received success factor (block 3036). The alignment logic 299 can then receive at least one value related to the sub-factor and/or super-factor (block 3038). The alignment logic 299 can then perform at least one calculation related to the received data (block 3040). The alignment logic 299 can then provide a graphical representation of the at least one calculation, where the graphical representation aligns the calculation with at least one reference point (block 3042).

The embodiments disclosed herein can be implemented in hardware, software, firmware, or a combination thereof. At least one embodiment disclosed herein may be implemented in software and/or firmware that is stored in a memory and that is executed by a suitable instruction execution system. If implemented in hardware, one or more of the embodiments disclosed herein can be implemented with any or a combination of the following technologies: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

One should note that the flowcharts included herein show the architecture, functionality, and operation of a possible implementation of software. In this regard, each block can be interpreted to represent a module, segment, or portion of code, which comprises one or more executable instructions for implementing the specified logical function(s). It should also be noted that in some alternative implementations, the functions noted in the blocks may occur out of the order and/or not at all. For example, two blocks shown in succession may in fact be executed substantially concurrently or the blocks may sometimes be executed in the reverse order, depending upon the functionality involved.

One should note that any of the programs listed herein, which can include an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, or transport the program for use by or in connection with the instruction execution system, apparatus, or device. The computer readable medium can be, for example but not limited to, an electronic, magnetic, optical, electromagnetic, infrared, or semiconductor system, apparatus, or device. More specific examples (a nonexhaustive list) of the computer-readable medium could include an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). In addition, the scope of the certain embodiments of this disclosure can include embodying the functionality described in logic embodied in hardware or software-configured mediums.

It should be emphasized that the above-described embodiments are merely possible examples of implementations, set forth for a clear understanding of the principles of this disclosure. Many variations and modifications may be made to the above-described embodiment(s) without departing substantially from the spirit and principles of the disclosure. All such modifications and variations are intended to be included herein within the scope of this disclosure.

One should also note that conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more particular embodiments or that one or more particular embodiments necessarily include logic for deciding, with or without user input or prompting, whether these features, elements and/or steps are included or are to be performed in any particular embodiment.

1. A system, comprising:
a determining component configured to determine at least one success factor related to a project;
a first receiving component configured to receive a data related to the success factor; and
a providing component configured to provide a graphical representation of the received data, wherein the graphical representation is configured to align at least a portion of the received data with at least one reference point.

2. The system of claim 1, wherein the received data is related to a desired value related to the success factor.

3. The system of claim 1, wherein the received data is related to an actual value of the success factor.

4. The system of claim 1, wherein the received data is related to a previous value of the success factor.

5. The system of claim 1, further comprising determining a tolerance value related to the received data.

6. The system of claim 5, further comprising determining whether at least a portion of the received data is aligned within the tolerance value of the reference point.

7. A method comprising:
determining at least one success factor related to a project;
receiving data related to the success factor; and
providing a graphical representation of the received data, wherein the graphical representation is configured to align at least a portion of the received data with at least one reference point.

8. The method of claim 7, wherein the received data is related to a desired value related to the success factor.

9. The method of claim 7, wherein the received data is related to an actual value of the success factor.

10. The method of claim 7, wherein the received data is related to a previous value of the success factor.

11. The method of claim 7, further comprising determining a tolerance value related to the received data.

12. The method of claim 11, further comprising determining whether at least a portion of the received data is aligned within the tolerance value of the reference point.

13. A method for system alignment, comprising the steps of:
establishing a set of success factors;
identifying a current value, a planned value, and a realized value for each success factor; and
presenting a graphical relation of at least one of the current, planned, and realized values for a plurality of success factors.

14. The method of claim 13, further comprising the steps of:
establishing a goal range for each of the success factors.
